(19) United States
(12) Patent Application Publication
(10) Pub. No.: US 2009/0309742 A1
(43) Pub. Date: Dec. 17, 2009

(54) DISASTER ALERT DISPLAY (DAD) EMERGENCY AND NATURAL DISASTER WARNING SYSTEM THAT AUTOMATICALLY DETECTS IF PEOPLE ARE CAUGHT IN AN EMERGENCY OR DISASTER, DETERMINES IF THEY ARE OK, AND NOTIFIES THEIR EMERGENCY CONTACTS

(76) Inventors: Jillian Alexander, Vancouver, WA (US); Scott Benedict Alexander, Vancouver, WA (US)

Correspondence Address: Disaster Alert Display, Inc., PO Box 820342, Vancouver, WA, 98682, US

(21) Appl. No.: 12/137,383

(22) Filed: Jun. 11, 2008

(51) Int. Cl. G01W 1/00

(52) U.S. Cl. 340/601

(57) ABSTRACT

One embodiment of an emergency alert system consisting of a data collector (102) that collects data from one or more data sources, a website (103) that collects information from customers, a central database (114) that stores all the information in the system, an alert engine (115) that figures out what alerts need to be sent and transmits those alerts to the correct devices, and mechanisms that allow users to receive alerts (116, 117 119, and 120). The website component (103) of the emergency alert system allows customers to create accounts, register devices such as mobile phones and computers, register email addresses, and register a list of emergency contacts. The data collector component (102) of the alert system receives and saves alerts from one or more data sources and the alert engine (115) transmits those alerts to customers. In advanced alert devices capable of knowing their current position (116 and 117), alerts are transmitted on those devices if the devices are near or in the area of effect of the alert. If the device detects that it is within the area of effect of the alert, it asks the customer if he/she is OK and transmits that response to the emergency alert system along with the current position of the device. Alerts are also sent to the customer's emergency contacts notifying them that the customer has been affected by an emergency and relaying that customer's current status and position. Other embodiments are described and shown.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to emergency and natural disaster warning devices/warning systems.

2. Prior Art

Emergency alert systems have been around for a long time. In the United States, the CONELRAD (Control of Electromagnetic Radiation) was established in 1951, was replaced by the Emergency Broadcast System (EBS) in 1963, which was replaced by the Emergency Alert System (EAS) in 1994. These systems, and similar systems, transmit emergency messages to televisions, radios, and other consumer devices, but require someone to be using and listening to one of these devices in order for this type of alert system to work.

Systems like the Emergency Alert System are limited in a number of ways:

(a) Someone must be listening to a radio, television, or similar device to receive alerts. People rarely use these devices for more than 10%-20% of the time. Furthermore, these devices can interfere with sleep and therefore are usually turned off while people are sleeping. For example, if there is a tornado warning in effect throughout the night, people who want to receive emergency alerts from a system like the Emergency Alert System would have to have a TV or radio turned on, and making noise, where they sleep.

(b) These devices for the most part are not portable and people are unlikely to carry a radio, television, or similar device with them wherever they go. It is even more unlikely that they would keep such a device turned on at all times.

(c) The precision in which they can transmit alerts is limited to the metropolitan area, rather than a county, city, postal code, or any other area that is more precise than a metropolitan area. For example, if there is a fire in the hills of Orange County, CA affecting a few thousand people, the entire Los Angeles metropolitan area, some 18 million people, would be warned.

(d) These systems do not suggest specific evacuation routes based on your current location.

(e) These systems have no way of determining who has been caught within the area of effect of an emergency or disaster.

(f) These systems have no way of determining if someone caught within the area of effect is OK.

(g) These systems do not attempt to alert emergency personnel when someone is caught in an emergency and is not OK.

(h) These systems do not notify people's emergency contacts when they are caught in an emergency or disaster.

(i) These systems are unaware of any special needs of people caught in the emergency or disaster, such as medical conditions, allergies, disabilities, etc.

There are many “Weather Radio” products on the market that are radios specifically designed to monitor an alert system, such as National Weather Service broadcasts, transmit emergency information vocally or on a written display, and possibly sound an alarm in the case of an emergency. These products are slightly better than the Emergency Alert System because they are focused on alerts and can be left on at night and stay silent unless there is an emergency, in which case they can sound an alarm to wake people up. Unfortunately, with the exception of limitation (a) stated on Page 2, these weather radio type systems are largely limited in the same ways that systems like the Emergency Alert System are limited.

The National Weather Service launched Weather Wire 2000 (Contracted by DynCorp) in June 2000. Weather Wire 2000 allows computer servers to receive emergency messages, natural disaster information, and weather related information via the Internet (as well as satellite dish). It allows government agencies to coordinate information and allows computer software to monitor, filter, and report information transmitted on the Weather Wire 2000 data feed. Weather wire 2000 information is usually location specific within a US county or a National Weather Service “Forecast Zone” (which is usually around the size of a county). This is an improvement over the Emergency Alert System and NWS Weather Radios and similar systems because it is more location specific and can be used to support computer systems and mobile devices (including mobile phones). It also contains a lot of data from different agencies, and is not limited to emergencies.

Several companies have come up with products based on the Weather Wire 2000 data feed. There are systems targeted for emergency workers as well as civilians that monitor alerts. These systems ask the user to specify an area or areas the user wants to receive alerts for, which is usually a US Postal ZIP code but could be an entire state, a National Weather Service Forecast Zone, a County “FIPS” code, a World Meteorological Organization Code, etc. and then notifies customers by email when there are alerts of the type and locations that the customer has requested.

These systems are a substantial improvement over systems like the Emergency Alert System or Weather Radios because they notify people in specific areas (such as specific counties), and because people are more likely to receive an alert email on their computer or mobile phone than they would from a TV or radio, particularly if that person uses a mobile phone or works at a computer terminal. Some of these systems even calculate evacuation routes.

These systems are still limited, however, because they do not attempt to automatically detect the customer's precise location, they do not determine if the customer is affected by an emergency or natural hazard, they do not automatically determine if affected customers are OK, and they do not notify customers' emergency contacts.

There are systems that attempt to calculate evacuation routes to avoid disasters or emergencies, but these systems still do not try to determine if the customer has been affected by the disaster or emergency, or if the customer is OK. These systems do not notify emergency contacts, emergency personnel, or attempt to provide important information like medical conditions of customers.

### SUMMARY

In accordance with one embodiment a computer system that collects and stores emergency and disaster related alerts, attempts to determine whether or not customers are in the area of effect of the emergencies or disasters, transmits these alerts to customers who may be affected by these alerts, attempts to determine whether or not each of those customers is OK, and records the customer's current position at regular intervals while customers are in the area of effect of a disaster or emergency, and to notify an emergency contact list for each customer that is affected by an emergency or disaster. This embodiment also provides a website interface to customer to allow customers to enroll in the system and to select preferences and to provide personal information.

### DRAWINGS—FIGURES

FIG. 1 shows the major components of the preferred embodiment.

FIG. 2 shows the program flow of the data collector component of the preferred embodiment.

FIG. 3 shows the front page (Index file) of the website component of the preferred embodiment and possible flows that can be reached from the front page of the website component of the preferred embodiment.

FIG. 4 shows the “new customer signup” flow of the website component of the preferred embodiment.

FIG. 5 shows the “customer login” flow of the website component of the preferred embodiment.

FIG. 6 shows the “modify personal information” flow of the website component of the preferred embodiment.

FIG. 7 shows the “register alert device” flow of the website component of the preferred embodiment.

FIG. 8 shows the “Register Special Needs” flow of the website component of the preferred embodiment.

FIG. 9 shows the “Modify Emergency Contact List” flow of the website component of the preferred embodiment.

FIG. 10 shows the “Download Software” flow of the website component of the preferred embodiment.

FIG. 11 shows the “Modify Subscription” flow of the website component of the preferred embodiment.

FIG. 12 shows the “Refer a friend” flow of the website component of the preferred embodiment.

FIG. 13 shows the “Verify E-Mail Address” flow of the website component of the preferred embodiment.

FIG. 14 shows the database layout/design of the central database component of the preferred embodiment.

FIG. 15 shows the program flow of the alert engine component of the preferred embodiment.

FIG. 16 shows the program flow of the application that runs on a mobile device component of the preferred embodiment.

FIG. 17 shows the program flow of the application that runs on a stationary device, an optional component of the preferred embodiment.

FIG. 18 shows how the preferred embodiment might optionally integrate with a system that calculates evacuation routes.

FIG. 19 lists the types of system generated text messages in the text message component of the preferred embodiment.

FIG. 20 lists the types of system generated e-mail messages in the e-mail component of the preferred embodiment.

FIG. 21 demonstrates the components of a mobile phone and how an application integrating the alert system with a mobile phone might look.

FIG. 22 demonstrates the components of an automobile navigation system and how an application integrating the alert system with an automobile navigation system might look.

FIG. 23 demonstrates the components of a personal computer and how an application integrating the alert system with a personal computer might look.

FIG. 24 demonstrates the components of a hand-held navigation device and how an application integrating the alert system with a hand-held navigation device might look.

FIG. 25 demonstrates the components of a specialized pager like device that connects with the alert system.

### DRAWINGS—REFERENCE NUMERALS

| | | | |
|---|---|---|---|
| (102) | Data Collector | (103) | Website |
| (114) | Central Database | (115) | Alert Engine |
| (116) | Application Running on Mobile Device | (117) | App Running on Stationary Device |
| (119) | Text Message Sent to Mobile Device | (120) | Alert Email |
| (201) | NWS Data Feed Parser | (202) | Collect Data until alert record is read |
| (203) | Normalize Alert Data | (204) | Duplicate (Yes/No)? |
| (205) | Don't Add Duplicate | (206) | Add New Alert |
| (211) | USGS Data Feed Parser | (212) | Collect Data until alert record is read |
| (213) | Normalize Alert Data | (214) | Duplicate (Yes/No)? |
| (215) | Don't Add Duplicate | (216) | Add New Alert |
| (221) | GDACS Data Feed Parser | (222) | Collect Data until alert record is read |
| (223) | Normalize Alert Data | (224) | Duplicate (Yes/No)? |
| (225) | Don't Add Duplicate | (226) | Add New Alert |
| (281) | ??? Data Feed Parser | (282) | Collect Data until alert record is read |
| (283) | Normalize Alert Data | (284) | Duplicate (Yes/No)? |
| (285) | Don't Add Duplicate | (286) | Add New Alert |
| (299) | Central Database | (301) | Front Page/Index |
| (302) | Optional Static Content | (401) | Signup page |
| (402) | Save new user account to database | (405) | Register emergency contact (Y/N)? |
| (406) | Register Another emergency Contact? | (501) | Customer Logs In |
| (502) | Login Correct? | (503) | Overview |
| (504) | Optional Content | (601) | Modify Personal Information |
| (602) | Save Changes? | (603) | Save Information to the Database |
| (701) | New or Existing Device? | (702) | Pick Existing Device |
| (703) | Update Info about Device | (704) | Save Updated Information to Database |
| (705) | Enter Information About New Device | (706) | Save new device info to database |
| (707) | Display Status Message | (801) | Modify Special Needs Information |
| (802) | Save Changes? | (803) | Save Updated info to the database |
| (901) | Add or remove emergency contact? | (902) | Enter contact info |
| (903) | Email already in system? | (904) | Add new user record for contact |
| (905) | Add new emergency contact record | (912) | Finished (Y/N)? |
| (1001) | Select file to download | (1002) | Download File (Y/N)? |
| (1003) | Download File | (1004) | Download another file (Y/N)? |
| (1101) | Modify Subscription | (1102) | Select Payment Method |
| (1103) | Authorize Payment | (1004) | Update User's Subscription Settings |
| (1201) | Refer a Friend | (1202) | Email Address in System? |
| (1203) | Add New user Record for referral | (1302) | Email Verification Code Correct? |
| (1303) | Display Incorrect Code Message | (1304) | Update email status to “Verified” |
| (1305) | Display Email Verified Message | (1311) | Manually verify Email Address |
| (1312) | Email verification code correct? | (1314) | Update email status to “Verified” |
| (1400) | Customer Related Tables | (1401) | Customer table |
| (1402) | Addresses table | (1403) | Email table |
| (1404) | Emergency Contacts Table | (1405) | Alert Devices Table |
| (1410) | Alert Related Tables | (1411) | Alerts table |
| (1412) | Customer Alert Notifications Table | (1413) | Emergency Contact Notifications |
| (1414) | Emergency Affected Customer Status | (1420) | Informational Tables |
| (1421) | Alert Types Table | (1422) | NWS Forecast Zones Table |
| (1423) | FIPS Codes Table | (1424) | Zip Codes Table |
| (1425) | Mobile Providers Table | (1429) | Other tables |
| (1501) | Query Database for new alerts | (1510) | For Each new notification |
| (1511) | Send Notification to registered devices | (1512) | Send notification by text message |
| (1514) | Add customer alert notification record | (1521) | Query DB for Contact Notifications |
| (1530) | For each contact notification | (1531) | Send notification to registered devices |
| (1532) | Send notification by text message | (1534) | Add emergency contact notification |
| (1540) | Central server for receiving messages | (1541) | API to receive messages from devices |
| (1542) | Save device info to database | (1601) | App receives info about an emergency |
| (1602) | Store Emergency Information | (1603) | Display location on map |
| (1604) | Sound alarm and display message | (1605) | Display countdown |
| (1611) | Application detects near emergency | (1621) | App detects moved into emergency |
| (1630) | While device is in emergency | (1631) | Ask user if he/she is OK? |
| (1632) | Transmit Response | (1633) | Wait for a time interval |
| (1635) | Determine current position | (1636) | Transmit position to alert system |
| (1637) | Wait for a time interval | (1640) | Central server receives and saves info |
| (1650) | Panic Feature | (1701) | App receives info on emergency |
| (1702) | Store emergency info | (1703) | Display location on map |
| (1704) | Sound alarm and display message | (1705) | Display countdown |
| (1711) | Application detects near emergency | (1730) | While in or near emergency |
| (1731) | Ask user if he/she is OK? | (1732) | Transmit Response |
| (1733) | Wait for a time interval | (1735) | Determine current position |
| (1736) | Transmit position | (1737) | Wait for a time interval |
| (1740) | Central server receives device info | (1750) | Panic Feature |
| (1801) | Map enabled mobile device | (1802) | Map display on mobile device |
| (1803) | Evacuation directions | (1804) | Current/Starting position |
| (1805) | Highlighted route | (1901) | Emergency Alert Text Message |
| (1902) | Emergency Contact Alert text message | (2000) | Security Related Emails |
| (2001) | Welcome new user email | (2002) | Verify Email Address Email |
| (2003) | Personal Info Updated Email | (2004) | Special Needs Info Updated Email |
| (2005) | Emergency Contact Added email | (2006) | Device added email |
| (2010) | Marketing Related Emails | (2011) | You're an emergency Contact Email |
| (2012) | Sign up email | (2020) | Alert Related Emails |
| (2021) | Emergency Alert Email | (2022) | Emergency Contact Alert Email |
| (2100) | Mobile Phone | (2101) | Audible Alert from Built-In speakers |
| (2102) | Message Display | (2103) | Input Means |
| (2200) | Automobile Navigation System | (2201) | Audible Alert through stereo |
| (2202) | Message Display | (2203) | Input Means |
| (2300) | Personal Computer | (2301) | Audible Alert |
| (2302) | Computer Display | (2303) | Input Means |
| (2304) | Application running in a window | (2400) | Hand-held navigation device |
| (2401) | Audible Alert | (2402) | Message Display |
| (2403) | Input Means | (2500) | Alert Device |
| (2501) | Audible Alert | (2502) | Message Display |
| (2503) | Input Means | | |

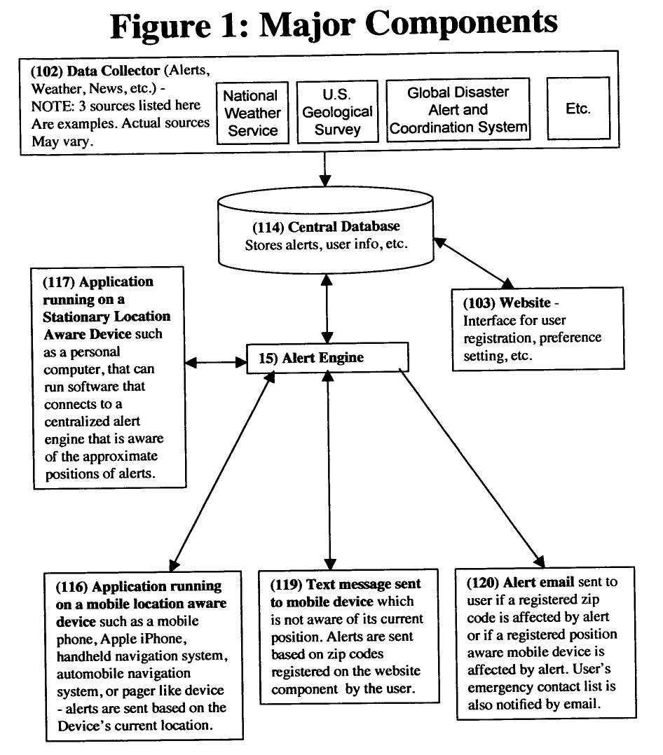

### DETAILED DESCRIPTION—FIGS. 1 THROUGH 20—PREFERRED EMBODIMENT

One embodiment of the emergency alert system (“emergency alert system” refers to the type of “thing” that this invention is, which is not to be confused by the US Federal Government's Emergency Alert System, which, if referenced, will be in capital letters) is illustrated in FIGS. 1 through 20. An overview of this embodiment of this emergency alert system is described in FIG. 1. This embodiment consists of 8 major components.

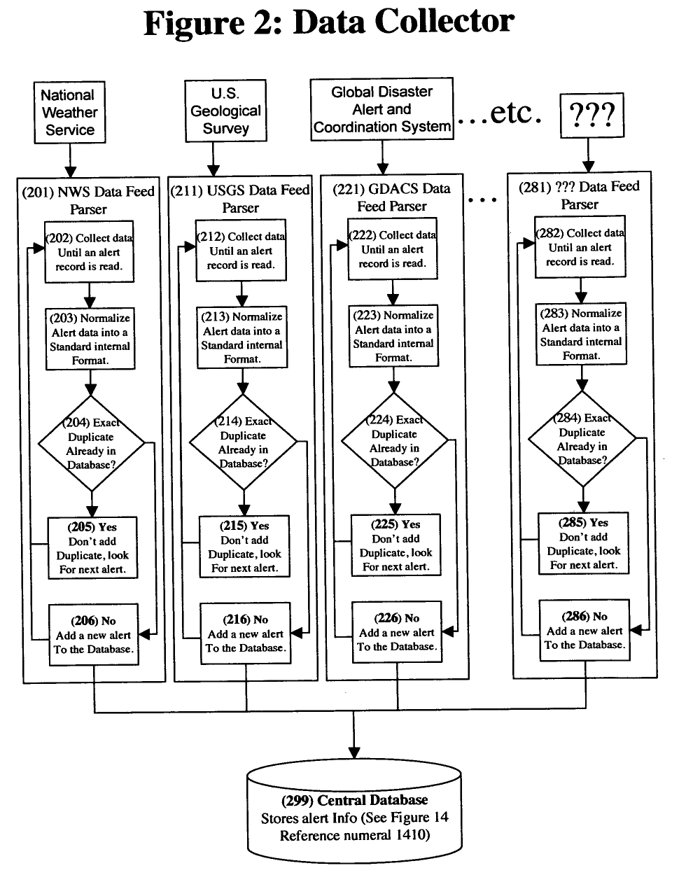

The data collector component (102), which is described in more detail in FIG. 2, is a continuously running software program that runs on one or more computers. It connects to one or more external data sources that provide emergency and/or natural disaster alerts. The data sources may optionally also provide news, hazard warnings, or other information. The data collector component (102) continuously collects data from the data source (or data sources) and adds new information to the central database server (114).

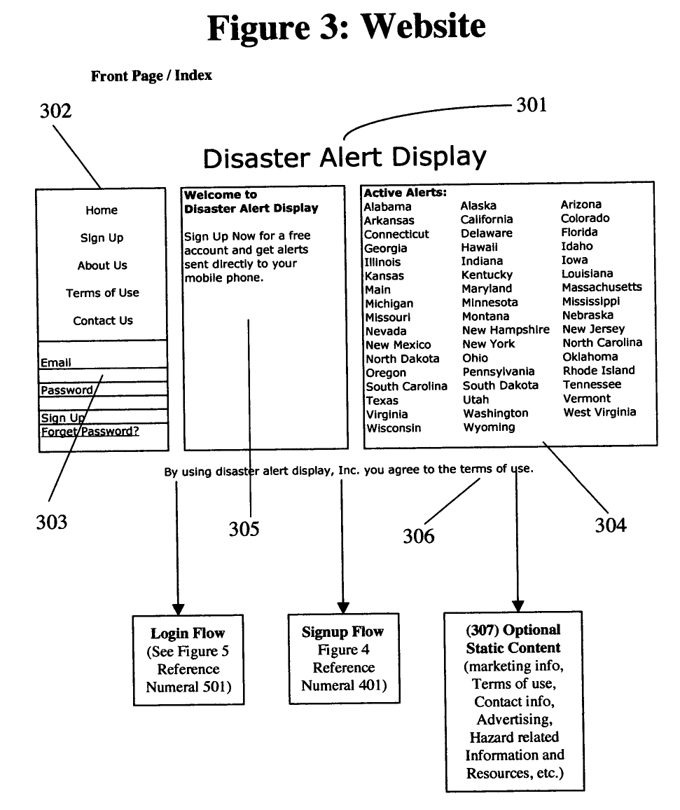

The website component (103), which is described in more detail in FIGS. 3 through 13, is a website application running on one or more webs servers connected to the Internet. The website component (103) provides a user interface to customers that allows customers to open up new accounts, configure their existing accounts, and access content such as news, educational materials, legal disclaimers, etc. The website component (103) connects to the central database server (114) component.

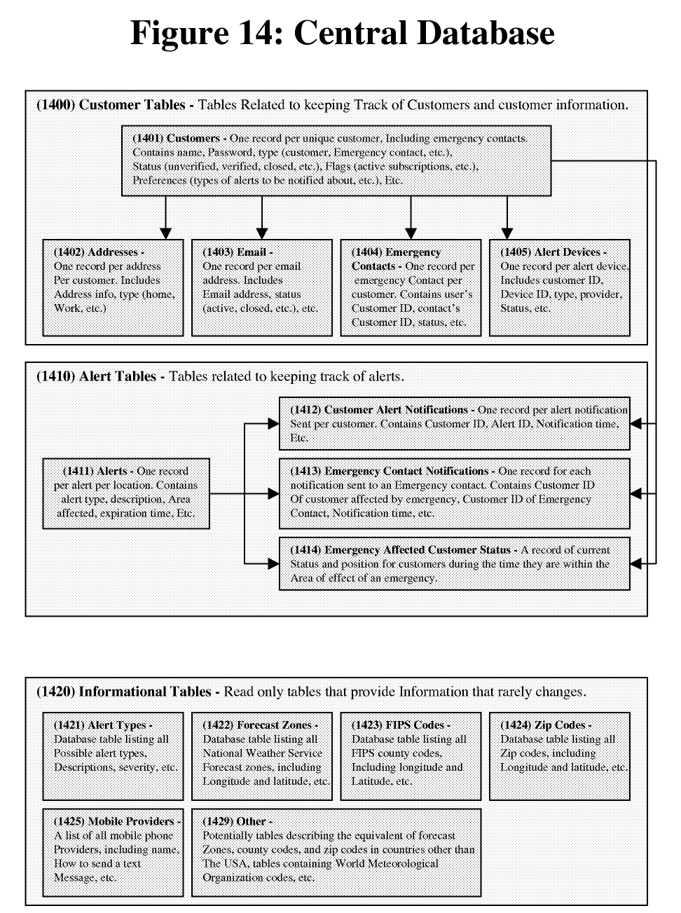

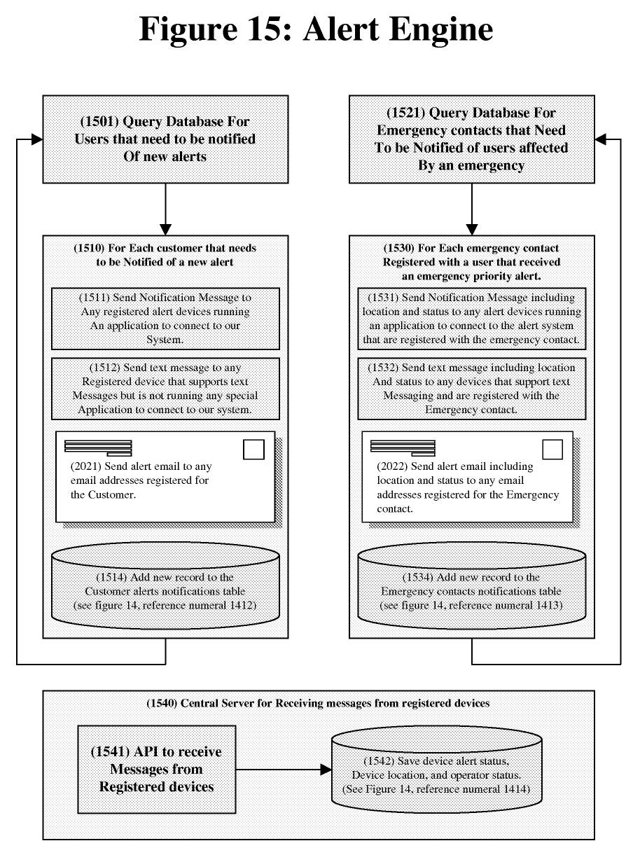

The central database server component (114), which is described in more detail in FIG. 14, is one or more database servers containing databases with tables and schema that store all necessary information for an embodiment of this emergency alert system. The central database server component (114) may optionally also consist of backup database servers. The central database server component (114) connects to the Data Collector component (102), the Website component (103), and the Alert Engine component (115).

The alert engine component (115), which is described in more detail in FIG. 15, is a continuously running software program that runs on one or more computers. It detects new alerts, determines which customers may be affected by those alerts, and sends out notifications to those customers. It also determines which emergency contacts should be notified and sends notification to those emergency contacts. The alert engine connects to the database server component (114), advanced mobile devices (116), advanced stationary devices (117), sends text messages to mobile devices (119), and sends e-mails (120).

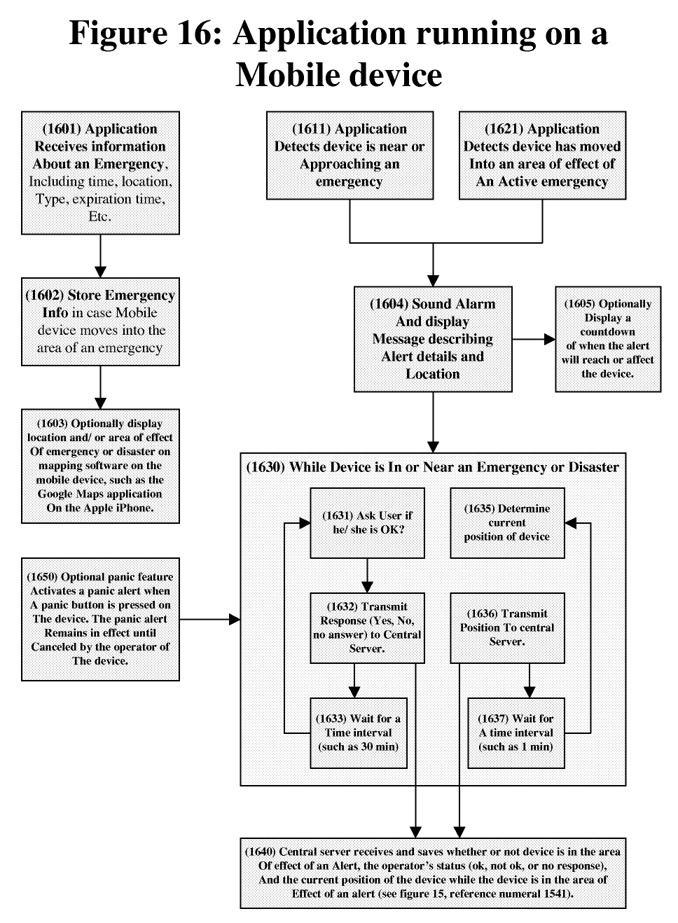

An application running on an advanced mobile device (116), which is described in more detail in FIG. 16, connects with the alert engine (115) and receives information on all alerts and is able to determine if the mobile device is in, or later moves into, the area of effect of an active alert. If it detects that the device is within the area of effect of an emergency or hazard, it can alert the user of the device through an alarm, message, and/or annotation on a map. This application can also ask the customer if he/she is OK and transmit the response back to the alert engine (115) where it is saved in the central database (114). When this application detects that the device is within the area of effect of an emergency, it can transmit the device's current location, if supported by the device, to the alert engine (115) where it is saved in the central database (114).

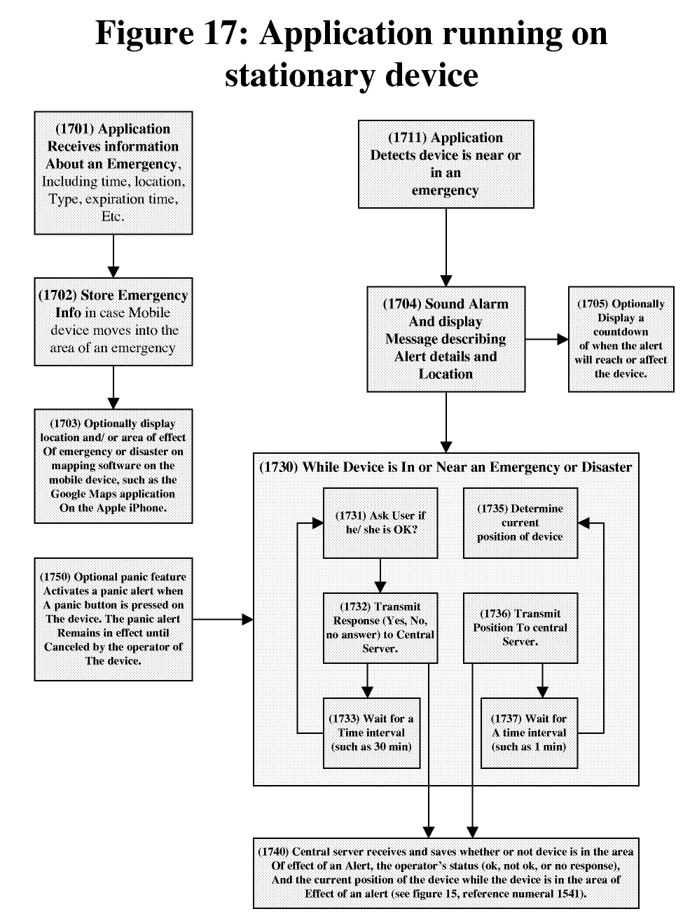

An application running on an advanced stationary device (117), which is described in more detail in FIG. 17, connects with the alert engine (115) and receives information on all alerts and is able to determine if the mobile device is in the area of effect of an active alert. If it detects that the device is within the area of effect of an emergency or hazard, it can alert the user of the device through an alarm, message, and/or annotation on a map. This application can also ask the customer if he/she is OK and transmit the response back to the alert engine (115) where it is saved in the central database (114). When this application detects that the device is within the area of effect of an emergency, it can transmit the device's current location, if supported by the device, to the alert engine (115) where it is saved in the central database (114).

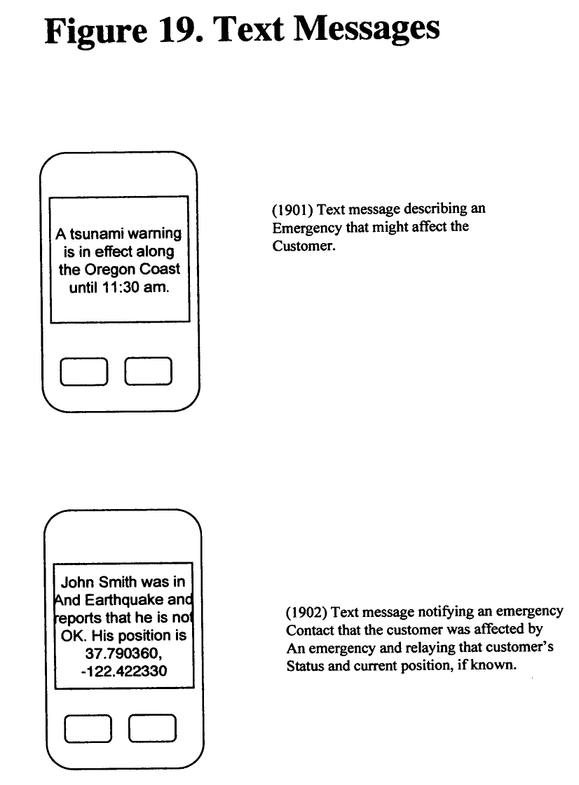

A text message component (119), which is described in more detail in FIG. 19, enables the alert engine (115) to send alert text messages to text message enabled devices, such as mobile phones and pagers, belonging to customers and emergency contacts.

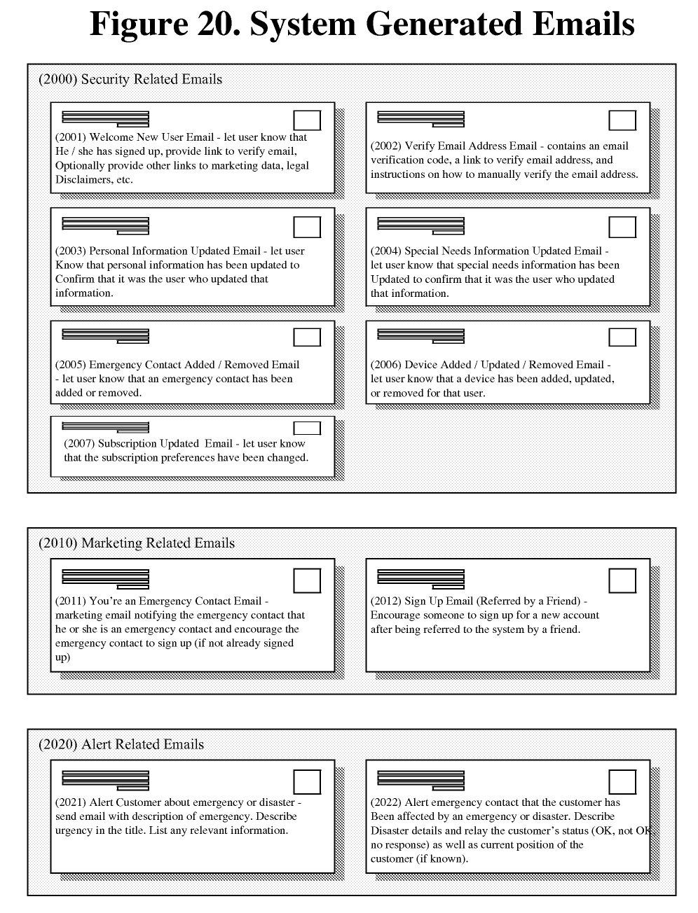

An email component (120), which is described in more detail in FIG. 20, enables the alert engine (115) to send alert emails to email addresses registered by the customers and to emergency contacts registered by the customers.

The data collector component of one embodiment is illustrated in detail in FIG. 2. This figure illustrates the logical flow of a data collector that connects to various data feeds and demonstrates that the data collector of a particular embodiment can support any number of, and combination of, emergency alert related data feeds.

An embodiment that connects to the National Weather Service's data feed (201) illustrates that data is read until a complete alert record is processed (202). The information is then normalized into a standard internal format (203). The data collector then determines whether or not there is already a duplicate alert stored in the database (204). If there is a duplicate, ignore the duplicate and look for the next alert (205). If there is not a duplicate, save the new alert information to the database (206). Alert information saved to the database (299) is illustrated in more detail in FIG. 14, reference numeral (1410).

The website component of one embodiment is illustrated in detail in FIGS. 3 through 13. The front page or index page of the website component of one embodiment is described in detail in FIG. 3. The front page (301) of the embodiment contains a side navigation bar (302) to navigate to other parts of the website accessible when the customer is not logged in, such as the signup page, informational pages, contact info, etc. The front page (301) of the embodiment also contains an interface for the user to log in (303). The front page (301) of the embodiment optionally contains a section that welcomes the customer to the site and /or displays other marketing related information and news (305). The front page (301) of the embodiment optionally contains an area that describes important news and/or high priority alerts (304). The front page (301) of the embodiment contains a section that displays the copyright and a link to other legal notices such as a terms of use agreement (306).

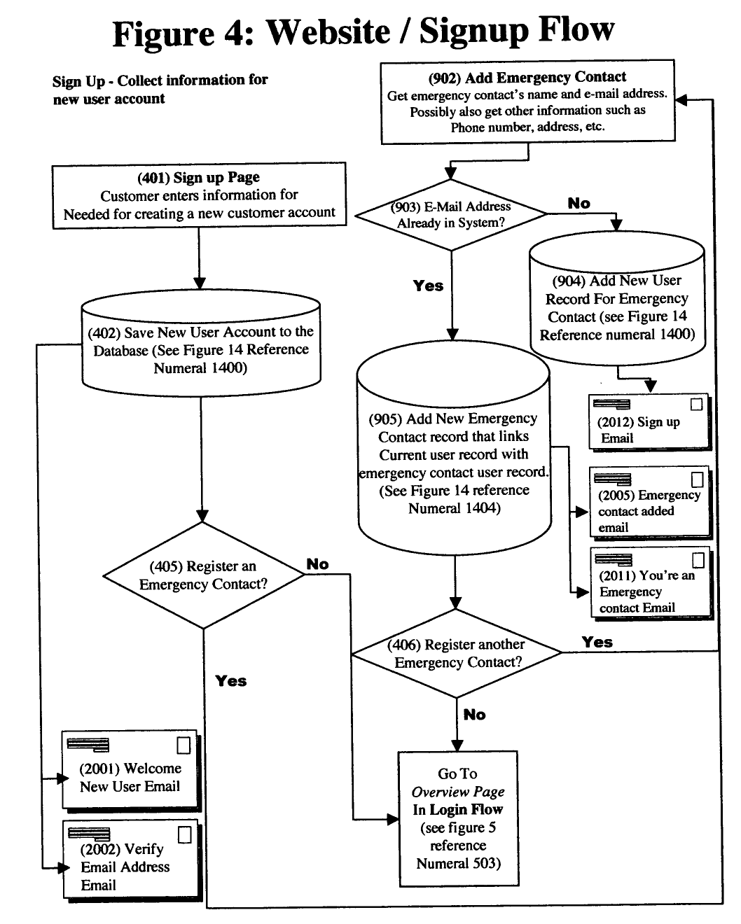

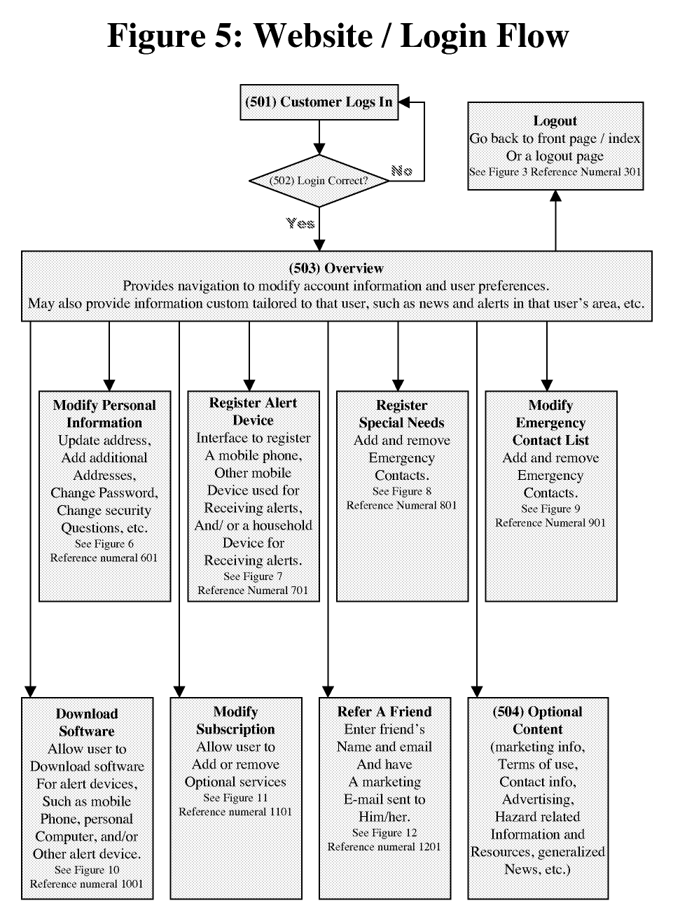

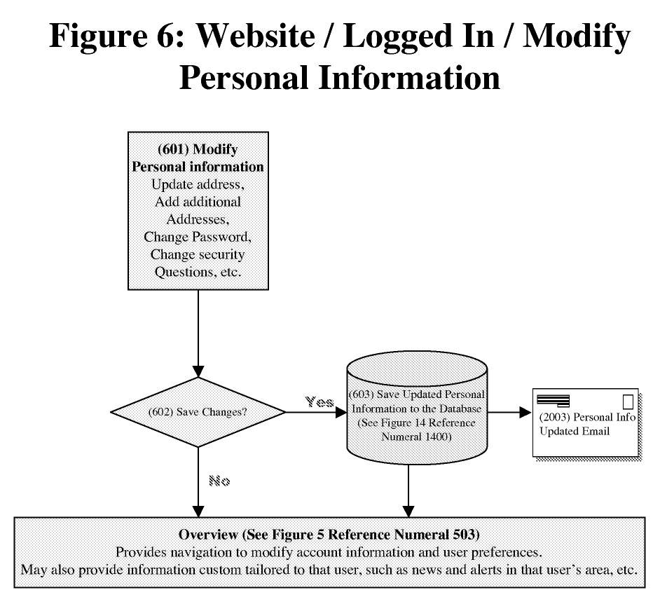

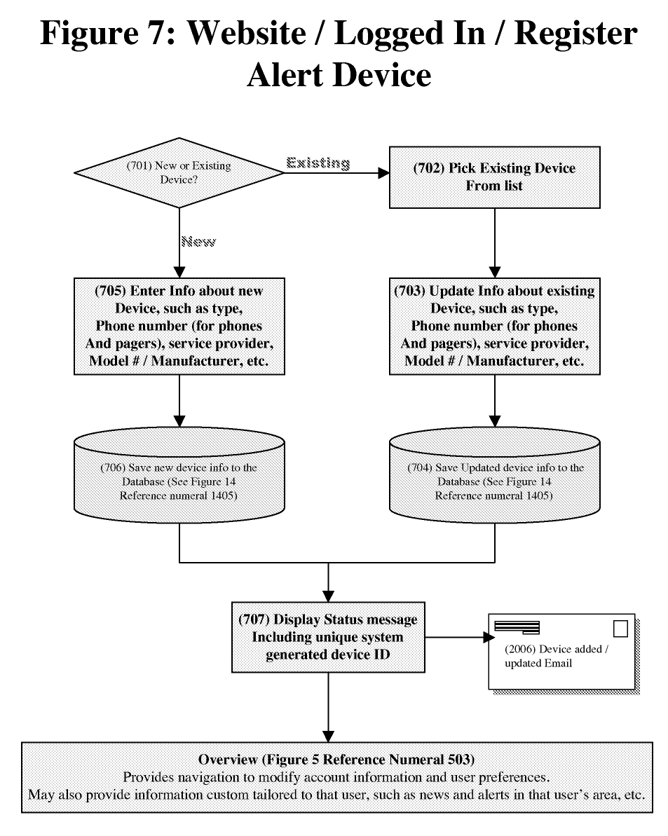

From the front page (301) of the embodiment, the customer can navigate to the login flow (501) described in FIG. 5, the signup flow (401) described in FIG. 4, or optional static content such as marketing information, educational resources, information about the company, etc. (307).

The “new customer signup” flow in the website component of one embodiment is illustrated in detail in FIG. 4. A signup form (401) allows the customer to enter new information necessary for opening up a new account. Once the sign up button is pressed at the bottom of the signup form (401), a new customer account is saved to the database (402) and system generated emails are sent to the customer to welcome the new customer (2001) and to verify the customer's email address (2002).

After signing up, the customer is asked if he/she wishes to add emergency contacts (405). If the customer wants to add emergency contacts, the customer is directed to a screen to enter information about the emergency contact to add (902) and the new emergency contact is added to the database (905). An emergency contact added email is sent both to the customer (2005) and the emergency contact (2011). If the emergency contact was not already in the system, a user record of type “emergency contact” is created (904) and an email is sent to the new emergency contact encouraging him/her to sign up as a customer (2012).

When the user is finished registering emergency contacts, the user is directed to the overview page in the login flow in FIG. 5 (503).

The “customer login” flow in the website component of one embodiment is illustrated in detail in FIG. 5. After the customer successfully logs on, the customer is directed to the “overview” page (503), which allows the customer to navigate to other parts of the site, log out, and view optional content (504). The overview page might optionally display information to the customer such as active alerts near the customer's registered addresses and devices, subscription information, etc.

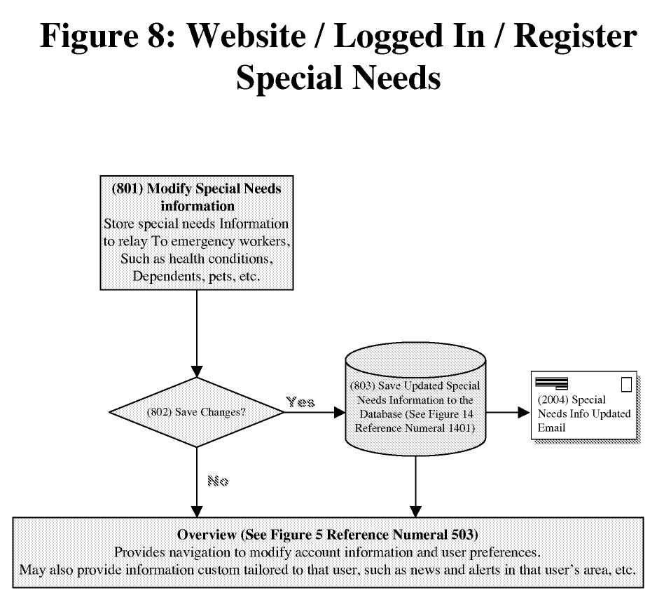

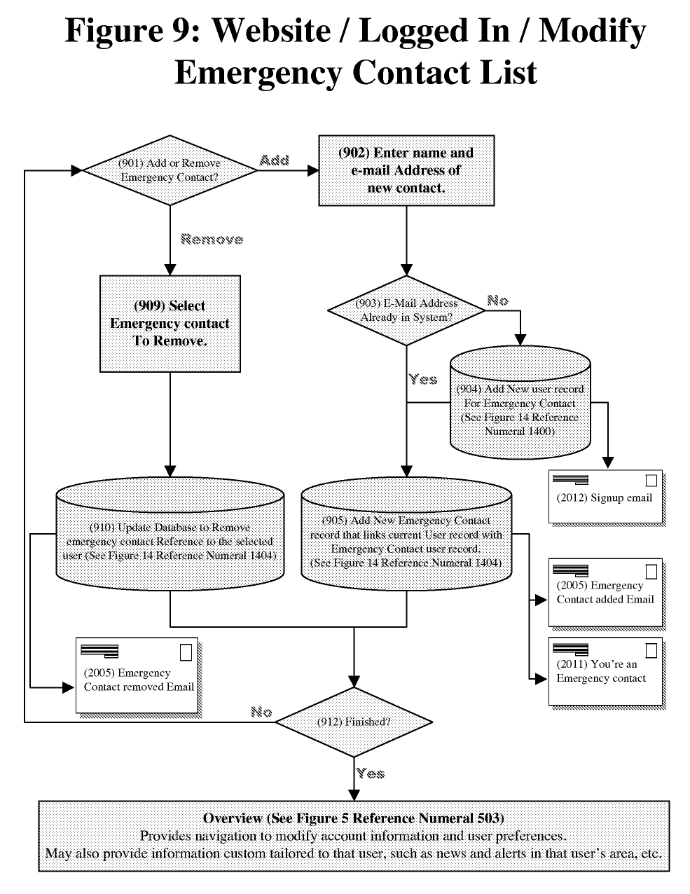

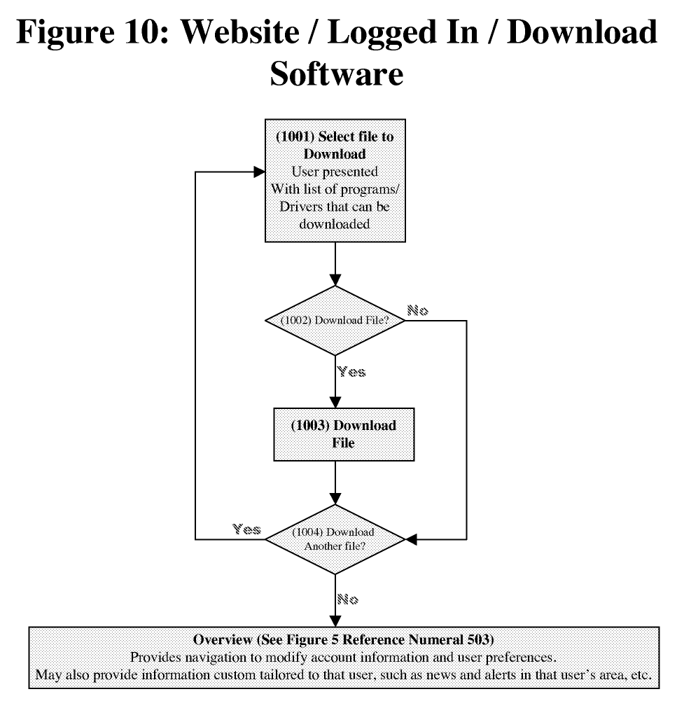

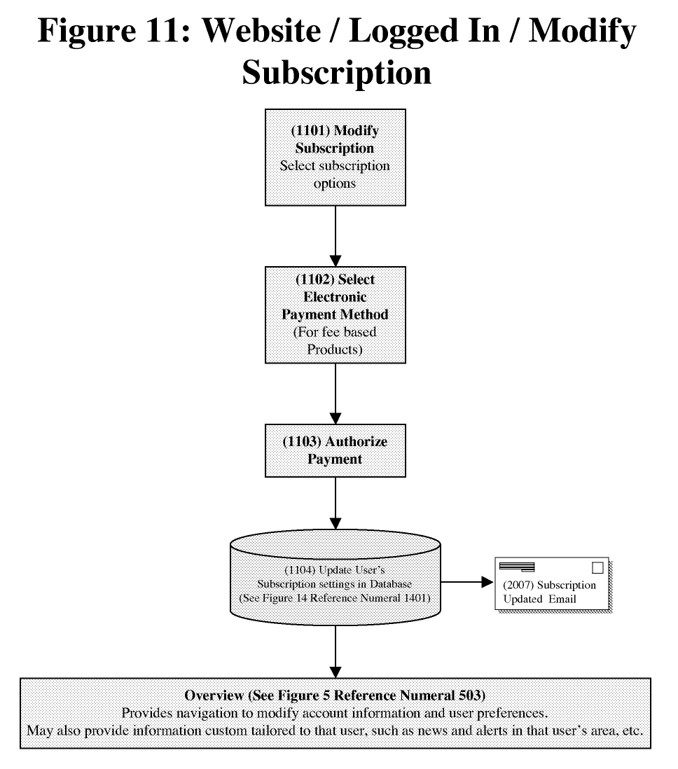

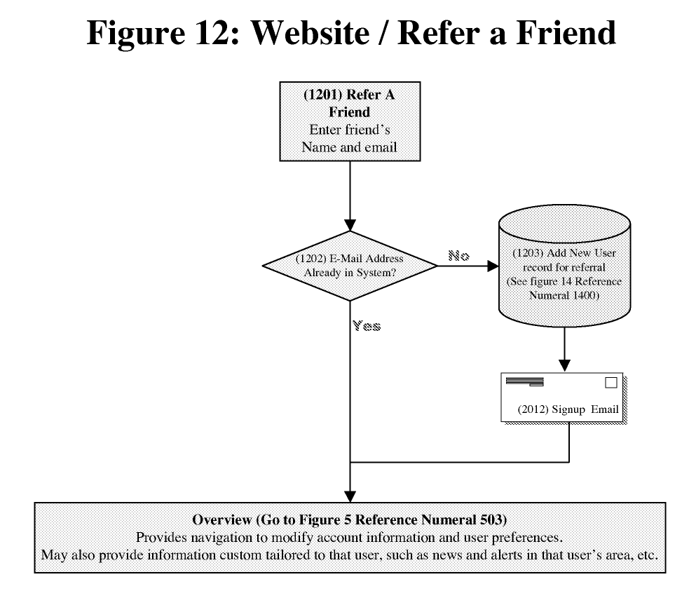

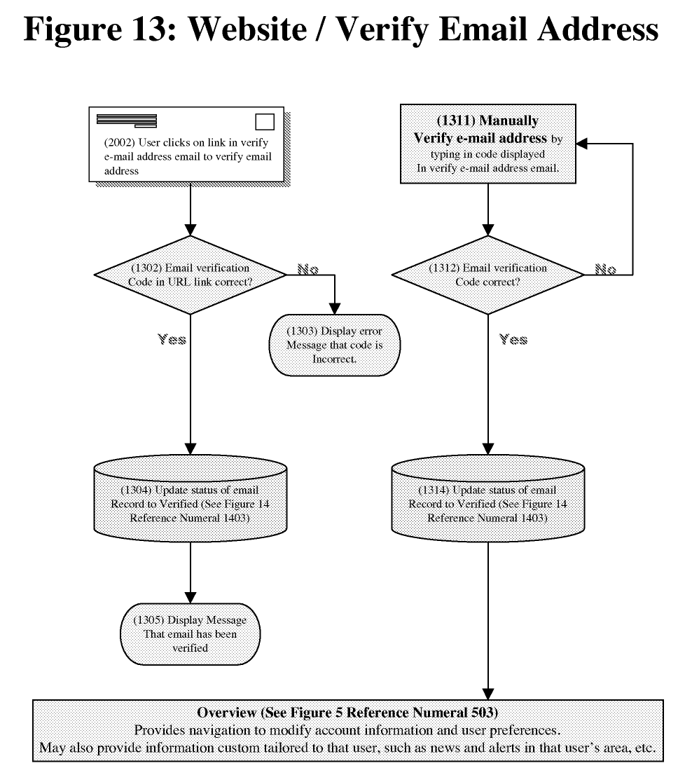

From the overview page (503) in the website component of this embodiment, the customer can navigate to “Modify Personal Information” described in FIG. 6 (601), “Register Alert Devices” described in FIG. 7 (701), “Register Special Needs” described in FIG. 8 (801), “Modify Emergency Contact List” described in FIG. 9 (901), “Download Software” described in FIG. 10 (1001), “Modify Subscription” described in FIG. 11 (1101), or “Refer a Friend” described in FIG. 12 (1201).

The “modify personal information” flow in the website component of one embodiment is illustrated in detail in FIG. 6. The customer is presented with a user interface that allows him or her to add/remove addresses, change his/her password, change security questions, etc. (601). If the customer then confirms if he/she wants to save the changes (602), the changes are saved to the database (603) and an email is sent to the customer confirming the changes (2003).

The “register alert device” flow in the website component of one embodiment is illustrated in detail in FIG. 7. The customer is asked if he/she wants to add a new device or modify an existing device (701). If the customer chooses to add a new device, the user is asked to enter information about the new device (705), the new information is saved to the database server (706), a status message is displayed (707), and an email is sent to the customer explaining what was changed (2006). If the user chooses to modify an existing device (701), the user is asked to pick a device from a list of existing devices (702), and update information about that device (703). The new information is saved to the database server (704), a status message is displayed (707), and an email is sent to the customer explaining what was changed (708).

The “register special needs” flow in the website component of one embodiment is illustrated in detail in FIG. 8. The customer is presented with a user interface to describe/enter any special needs (801). The user is then asked if he/she wants to save changes (802), and if the user wants to save the changes, they are saved in the database (803), and an email is sent to the user explaining that the special needs have been updated (2004).

The “modify emergency contact list” flow in the website component of one embodiment is illustrated in detail in FIG. 9. The customer is asked if he/she wants to add or remove an emergency contact (901). If the customer wants to add a new emergency contact, the customer is asked for the name and email address of the new contact (902). If the email is not already in the system, a new user record is created for the emergency contact (904) and an email is sent encouraging the new emergency contact to sign up (2012). Then a new emergency contact record is set up for the customer that points to the customer ID of the new emergency contact (905). An e-mail is sent to the customer stating that an emergency contact has been added (2005) and an e-mail is sent to the emergency contact letting him or her know that he/she is an emergency contact (2011).

In the event that the email address is already in the system (903), a new emergency contact record is added which links the customer with the customer ID of the emergency contact (905). An emergency contact added email is sent to the customer (2005), and an email is sent to the emergency contact notifying him or her that he/she is an emergency contact.

In the event that the customer wants to remove an emergency contact (901), the user is presented with a list of emergency contacts to select from (909), the database is updated (910), and an email is sent to the customer notifying him/her that an emergency contact has been removed (2005).

The “download software” flow in the website component of one embodiment is illustrated in detail in FIG. 10. The customer is presented with a list of programs, applications, and drivers that can be downloaded to computers, mobile devices, or other devices (1001). These software programs can be used to enhance the functionality of the alert system for the customer. When the customer selects a file to download, he/she will be asked to confirm the download (1002), and once confirmed, the download of the file will commence (1003).

The “Modify Subscription” flow in the website component of one embodiment is illustrated in detail in FIG. 11. The customer is presented with a user interface that lets him/her select product options to subscribe to (1101). Once these products are selected, the customer will be asked to provide electronic payment details to pay for any fee based products (1102). Once the payment is authorized (1103), the subscription settings are updated in the database for the customer (1104), and a subscription updated email is sent to the customer (2007).

The “Refer a Friend” flow in the website component of one embodiment is illustrated in detail in FIG. 12. A customer can enter a friend's name and e-mail address (1201), and if the email address is not already in the system (1202), a new user record of type “referral” is saved to the database (1203) and a signup email is set to the referee (2012).

The “verify email address” flow in the website component of one embodiment is illustrated in detail in FIG. 13. The customer clicks on a link in the “verify email address” email (2002) that directs the customer to a email verification URL and passes parameters containing the customer's e-mail e-mail address and the verification code. If the code is not correct (1302), an error message is displayed (1303). Otherwise, the email record in the database is updated with a status of “verified” (1304) and a message is displayed confirming that the email has been verified (1305).

Alternatively, the customer can manually verify the email address by clicking in a “verify email address” link while logged in. The customer is presented with a user interface to type in the verification code (1311), and if the code is correct (1312), the email record in the database is updated with a status of “verified” (1314) and the customer is redirected to the overview page (503), where there is an indication that the email address is now “verified”.

The central database component of one embodiment is illustrated in detail in FIG. 14. The central database component runs on one or more database servers and optionally has one or more database servers with real time replication of data from the primary database servers to the backup database servers. There are three main categories of information: the customer tables (1400), the alert tables (1410), and the Informational tables (1420).

The Customer tables (1400) in the central database component of one embodiment consist of tables related to each customer. The “Customers” table (1401) has one record per customer, including emergency contacts and referrals. It contains information specific to a customer, such as a unique customer ID, the customer name, password, type (customer, emergency contact, referral, etc.), status (unverified, verified, closed, etc.), flags (subscription settings, etc.), preferences (types of alerts to be notified about, etc), etc.

The “addresses” table (1402) has one record per address per customer. The address record contains the actual address, the type of address (home, work, vacation home, etc.), and any other information associated with an address.

The “email” table (1403) has one record per email per customer. The table includes the actual email address, the status (unverified, verified, closed, etc.), etc. Each customer must have at least one e-mail address, and an email address cannot be shared between two customers.

The “emergency contacts” table (1404) links the customer record (1401) of the customer with the customer record(s) (1401) of the customer's emergency contact(s). Each record contains the unique customer ID of a customer, the unique customer ID of an emergency contact, a status (active, closed, etc.), and any other information relevant to identifying a customer as an emergency contact of another customer.

The “alert devices” table (1405) has one record per alert device per customer. An “alert device” is a device running an application that can communicate with the alert system. Examples could include, but are not limited to, an advanced mobile phone, such as an Apple iPhone, a personal computer, a specialized device similar to a “weather radio”, or an automobile's navigation system. An alert device can also be a device that is not running a specialized application but is still able to communicate with the alert system. For example, most lower end mobile phones can still receive text messages from the alert system. The “alert devices” table (1405) includes a device ID, a customer ID, the type of device, the provider (such as mobile phone company), the status (active, no longer in use, etc.), etc.

The Alert tables (1410) in the central database component of one embodiment consist of tables related to alerts. The “alerts” table (1411) has one record per alert per location. Each record contains an alert type, a description, area of effect, location/zone, expiration time, etc.

The “customer alert notifications” table (1412) has one record per alert notification send per customer. This is both an audit trail of what alerts were sent to what customers and at what time, as well as a way to determine who still needs to be notified of a given alert (allowing the alert engine (FIG. 1, reference numeral 115) to run on multiple machines and allowing notifications to continue if a machine running the alert engine crashes. The “customer alert notifications” table (1412) contains the customer ID of the customer, the alert ID of the alert, the notification time, priority/severity of the alert, etc.

The “emergency contact notifications” table (1413) has one record per emergency priority/severity “customer alert notification” (1412) per emergency contact for the customer ID of each “customer alert notification” (1412). The “emergency contact notifications” table (1413) contains the customer ID affected by an emergency, the customer ID of the emergency contact, the alert ID of the emergency affecting the customer, the time in which the notification was sent to the emergency contact, the current known status of the customer affected by the emergency, etc.

The “emergency affected customer status” table (1414) has one record per status response per customer affected by an emergency. When a customer is in the area of effect of an emergency, some alert devices are capable of asking the customer at a regular interval if he/she is OK. Each time the device asks the customer if he/she is OK, the response (yes, no, or no answer) is saved in a record in the “emergency affected customer status” table (1414). The “emergency affected customer status” table (1414) contains the customer ID, the date and time of the status update, the alert ID of the alert affecting the customer, the customer's position (if known), the customer's status (OK, not OK, no answer), etc.

The informational tables (1420) in the central database component of one embodiment consist of tables that provide supporting information that is relatively unchanging. The “alert types” table (1421) contains one record for each alert type that is supported by the alert system. It contains a unique ID for the alert type, a description of the alert type, the severity/urgency of the alert type, etc.

The “forecast zones” table (1422) contains one record for each National Weather Service Forecast Zone. A forecast zone is an area defined by the United States national weather service, and many alerts reported by the national weather service (such as through the Weather Wire 2000 system) are reported by forecast zone. Forecast zone records include the zone number, state, a description, and boundaries specified in longitude and latitude, etc.

The “FIPS Codes” table (1423) is a listing of all counties in the United States based on the FIPS standard. FIPS code records include the FIPS code identifying the county, the state, a description, and boundaries specified in longitude and latitude.

The “ZIP Codes” table (1424) is a listing of all US Postal Service ZIP codes, including the ZIP code, description, state, county FIPS code, boundaries specified in longitude and latitude, etc.

The “Mobile Providers” table (1425) is a list of all mobile phone providers, including a provider ID, the provider name, the format for e-mailing a text message, etc. This table is used to support sending text messages to customer's registered mobile phones, as well as supporting communicating with mobile phone devices.

A particularly embodiment may contain other informational tables, such as supporting World Meteorological Organization codes, international locations, international postal codes, etc.

The Alert Engine component of one embodiment is illustrated in detail in FIG. 15. The alert engine is a software program running on one or more computers that can connect to the central database server (see FIG. 14). There are three major components to the alert engine.

The first component is a software routine that continuously queries the database for customers that need to be notified about active alerts (1501). For each customer that needs to be notified of an active alert (1510): a) details about the alert are sent to any registered devices supporting advanced alert features belonging to that customer (1511), such as an Apple iPhone running a software application supporting the alert system, b) a text message about the alert is sent to any registered device that supports text messages but does not support advanced alert features (1512), such as a basic mobile phone, c) sends an alert email to any emails registered with the customer (2021), and d) adds a new record to the customer alert notifications table (1514) marking that the customer has been notified.

The second component of the alert engine component of one embodiment is a software routine that continuously queries the database for emergency contacts that need to be notified of customers affected by emergency level alerts (1521). For each emergency contact registered with a user that received an emergency priority alert (1530), a) the name, contact information, position, current status, and any other relevant information is sent to any alert device capable of advanced alert features, such as an Apple iPhone running a software application supporting the alert system, registered with the emergency contact (1531), b) a text message containing the name, contact info, position, current status, and any other relevant information is sent to any alert device registered with the emergency contact that supports text messages but does not support advanced alert features (1532), such as a basic mobile phone, c) an email containing the name, contact information, position, current status, and any other relevant information is sent to any email address registered with the emergency contact (1533), and d) adds a new record to the emergency contact notifications table (1534) marking that the emergency contact has been notified.

The third component of the alert engine component of one embodiment is a software routine on a central server that provides an API for registered devices (see FIGS. 16 and 17). The API (1541) receives information from the devices such as a unique identifier for the device, whether or not the device is in the area of effect of an alert, the location of the device while the device is in the area of effect of an alert, and the status of the human operator of the device (OK, not OK, or no response). The information received by the API is saved to the central database (1542).

The application running on a mobile device component of one embodiment is illustrated in detail in FIG. 16. This application, or collection of applications, supports advanced alert features on mobile devices, such as an Apple iPhone, Blackberry phone, the navigation system in an automobile, a portable GPS navigation system, or a GPS enabled mobile phone that are capable of determining their approximate location. When the application receives information from the alert system about an emergency (1601), that information is stored in memory until the emergency expires (1602).

The application may optionally display the location of the alert or the area of effect of the alert if the device has a mapping capability (1603). For example, the area of effect of a Tsunami warning might appear in red along coastal regions of a map on a navigation system or on the Google maps feature of an Apple iPhone.

At a regular interval, the application on the mobile device checks to see if the device is near or approaching an emergency (1611), or if the device has moved into the area of effect of an emergency (1621). If either is the case, an alarm is sounded and a message is displayed with alert details and location (1604). This alarm may differ in sound or intensity based on the urgency of the emergency or whether or not the device is near the emergency or actually in its area of effect. In the case of imminent and life threatening emergencies, the application may attempt to override volume settings and “silent mode” on mobile devices and may attempt to sound the alarm at the maximum volume supported by the device. For example, in one embodiment if a mega-thrust 9.0 earthquake is going to hit Seattle within the next 5 minutes, and someone is in a business meeting with his/her phone in silent mode, the alarm would sound on that person's mobile phone at maximum volume and state in plain English “Severe Earthquake Alert”.

Particularly in the case of alerts that are moving and approaching towards the device but not yet affecting the device, such as a tsunami, hurricane, or even an earthquake, one embodiment may optionally display a countdown of when the alert is expected to reach or affect the device (1605). For example, in the event of a Tsunami, the epicenter, time of initial occurrence, direction, and speed could be known and from that the application on the device could calculate approximately when the tsunami would reach the device and initiate a countdown.

While the device is in or near an emergency or disaster (1630), a user interface will appear on the device asking the customer if he/she is OK (1631). The response (OK, not OK, or no answer), as well as the fact that the device is in or near the area of effect of an alert, is transmitted to a central server that is part of the alert system (1632) and the response is received and recorded by the central server (1640). The application then waits for a given time interval (such as 30 minutes) before following up with the customer and asking the customer for an updated status (1633).

While the device is in or near an emergency or disaster (1630), the application also determines the current position of the device (1635). The position, as well as the fact that the device is within the area of effect of an alert, is transmitted to a central server that is part of the alert system (1636) and the position is received and recorded by the central server (1640). The application then waits a given time interval (such as 1 minute) and re-transmits the current position (1637).

The application on the device may optionally support a panic feature (1650) that initiates a panic alert and transmits the information to the central server. For example, a woman who is approaching her car and sees a suspicious person following her could press a panic button on the touch screen of her iPhone and it would initiate a panic alert and start transmitting the location of her iPhone to the central server. If she gets in her car and is OK, she can respond that she is OK and the panic alert will cancel. If the panic alert is not canceled or she responds that she is not OK, a message would be sent to her husband's mobile phone including the current location of her iPhone. This has advantages over 911 for three reasons. First, people are reluctant to dial 911 if they see someone who might be a threat but they have no proof. Once they realize there is a threat, it is too late. Second, 911 often has a delay in when an operator picks up, so by the time an operator responds, it may be too late to tell someone, for example, that she is being abducted. Third, the panic feature silently tracks your position.

An example of how the panic feature might be implemented on an Apple iPhone is illustrated in FIG. 26. A panic button (2610) is placed on the main menu (2601) of the iPhone. When the panic button is pressed and the phone is not in panic mode, the human operator is asked to confirm the panic mode (2602). If the human operator confirms panic mode, panic mode is initiated and a panic alert is active. The application goes back to the main menu of the phone and there is no indication that the phone is in panic mode.

If the panic button (2610) is pressed while the phone is in panic mode, it will indicate that the phone is in panic mode and request a password. During the initialization process when the application was first installed, the customer has established an “OK” password and a “Not OK” password. Either password will make it appear as if the panic mode has been canceled, but panic mode will only be canceled if the OK password is used. This allows the human operator to make a threat that is aware of the panic mode to think that the panic mode has been canceled when in fact it has not. A not OK password would be received by the alert system and forwarded to the emergency contact list.

The application running on a stationary device component of one embodiment is illustrated in detail in FIG. 17. This application, or collection of applications, supports advanced alert features on stationary devices such as a personal computer. These devices may be able to automatically determine their locations, such as a laptop computer with a GPS card, or they could determine the location when the application is first initialized by specifying an address and calculating the longitude and latitude from the address. When the application receives information from the alert system about an emergency (1701), that information is stored in memory until the emergency expires (1702).

The application may optionally display the location of the alert or the area of effect of the alert on third party mapping software such as Google maps (1703). For example, the area of effect of a Tsunami warning might appear in red along coastal regions of a web browser window displaying Google maps.

At a regular interval, the application on the device checks to see if the device is near an emergency (1711). If so, an alarm is sounded and a message is displayed with alert details and location (1704). This alarm may differ in sound or intensity based on the urgency of the emergency or whether or not the device is near the emergency or actually in its area of effect. In the case of imminent and life threatening emergencies, the application may attempt to override volume settings and “silent mode” on the device.

Particularly in the case of alerts that are moving and approaching towards the device but not yet affecting the device, such as a tsunami, hurricane, or even an earthquake, one embodiment may optionally display a countdown of when the alert is expected to reach or affect the device (1705). For example, in the event of a Tsunami, the epicenter, time of initial occurrence, direction, and speed could be known and from that the application on the device could calculate approximately when the tsunami would reach the device and initiate a countdown.

While the device is in or near an emergency or disaster (1730), a user interface will appear on the device asking the customer if he/she is OK (1731). The response (OK, not OK, or no answer), as well as the fact that the device is in or near the area of effect of an alert, is transmitted to a central server that is part of the alert system (1732) and the response is received and recorded by the central server (1740). The application then waits for a given time interval (such as 30 minutes) before following up with the customer and asking the customer for an updated status (1733).

While the device is in or near an emergency or disaster (1730), the application also determines the current position of the device (1735). The position, as well as the fact that the device is within the area of effect of an alert, is transmitted to a central server that is part of the alert system (1736) and the position is received and recorded by the central server (1740). The application then waits a given time interval (such as 1 minute) and re-transmits the current position (1737).

The application on the device may optionally support a panic feature (1750) that initiates a panic alert and transmits the information to the central server. For example, a woman who is working at her computer at home might hear someone break into the house and she immediately presses a panic button on the alert application on her computer. The application would initiate a panic alert. The panic alert feature is more useful for mobile devices, but might still have value with stationary devices.

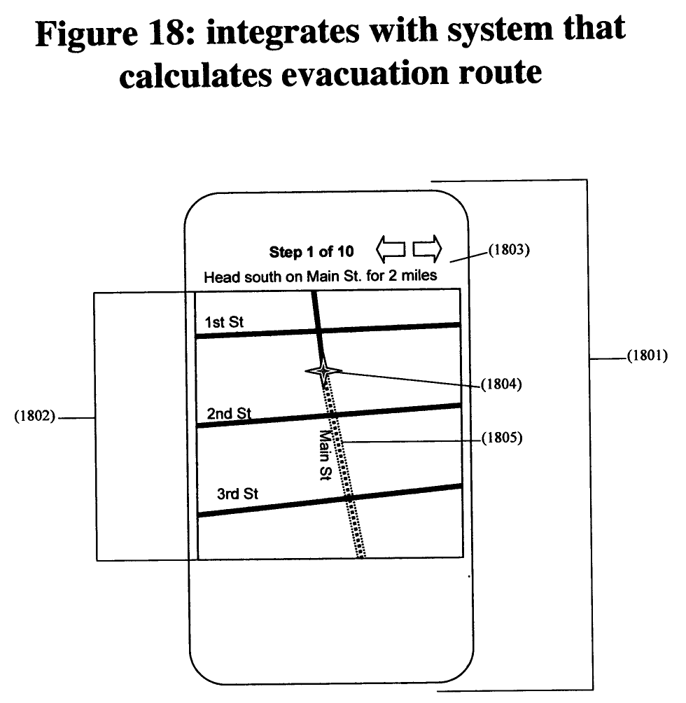

FIG. 18 shows how one embodiment of the alert system may optionally integrate with a system that calculates evacuation routes. If an application running on an alert device (FIGS. 16 and 17), it could integrate with a system that calculates evacuation routes and display an evacuation route on a map, including the devices current location, step by step driving directions for the evacuation route, the current location of a disaster, and the expected area of effect of the disaster.

FIG. 18 illustrates an Apple iPhone (1801) with a street map (1802), step by step driving directions (1803), the current location of the device (1804), and a highlighted driving route on the map (1805). The map could also have in a highlighted color areas expected to be affected by the disaster, such as the areas expected to be flooded by an approaching tsunami.

FIG. 19 illustrates how system generated text messages could look in one embodiment of the emergency alert system. An emergency alert text message notifies customers of emergencies (1901). An emergency contact notification text message notifies emergency contacts that someone was in the area of effect of an emergency (1902).

The system generated emails of one embodiment of an emergency alert system are listed in FIG. 20. There are three main categories of system generated emails: emails related to security (2000) which alert customers by email to any changes to their accounts, emails related to sales and marketing (2010), and emails related to alerts (2020).

The security related emails (2000) of one embodiment notify a customer every time something changes in his or her account. The “Welcome New User” email (2001) notifies the customer that an account has been created. The “Verify Email Address” email (2002) contains a verification code so that the customer can prove that he/she has access to the email address provided for the account. The “personal information updated” email (2003) notifies the customer by email whenever personal information is updated. The “special needs” email (2004) notifies the customer every time the special needs memo is updated. The “emergency contact added/removed” email (2005) notifies the customer every time an emergency contact has been added or removed. The “device added/updated/removed” email (2006) notifies the customer every time an alert device has been added, updated, or removed from the account. The “subscription updated” email (2007) lets the customer know that the subscription preferences have been updated.

The marketing related emails (2010) of one embodiment are sent to potential customers to try to convince them to sign up as a customer. The “You're an emergency contact” email (2011) notifies people when they have been added as someone else's emergency contact. If they are not already in the system, they are also presented with information about the alert system and how to sign up. The “sign up” email (2012) is sent to people as friend referrals, or to new emergency contacts not already in the system, or as part of a marketing campaign. It promotes the alert system and instructs the recipient on how to sign up for a new account.

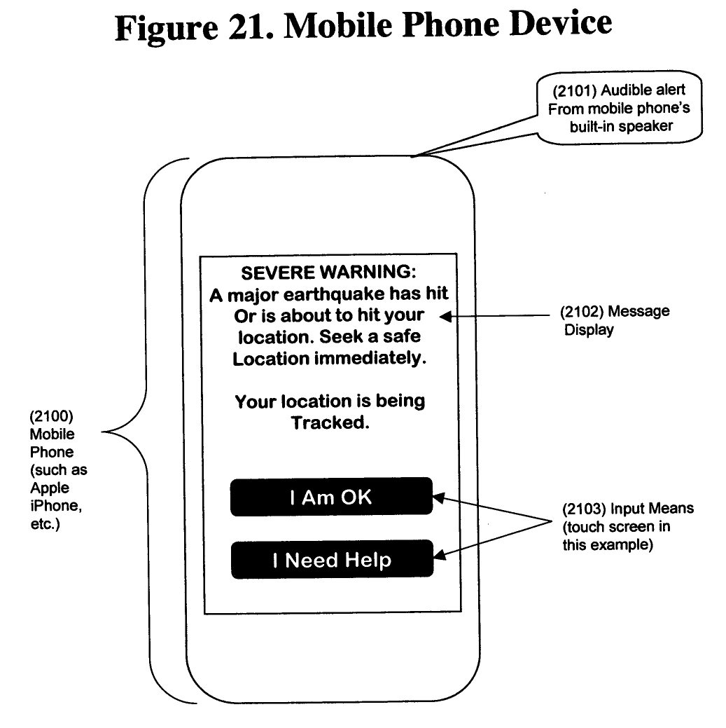

FIG. 21 illustrates how one embodiment of the alert system might look on a mobile phone such as the Apple iPhone. The application runs on the mobile phone (2100) consisting of a built in speaker to be used for audible alerts (2101), a message display to display alert messages (2102), and an input means for indicating whether or not the human operator is OK (2103).

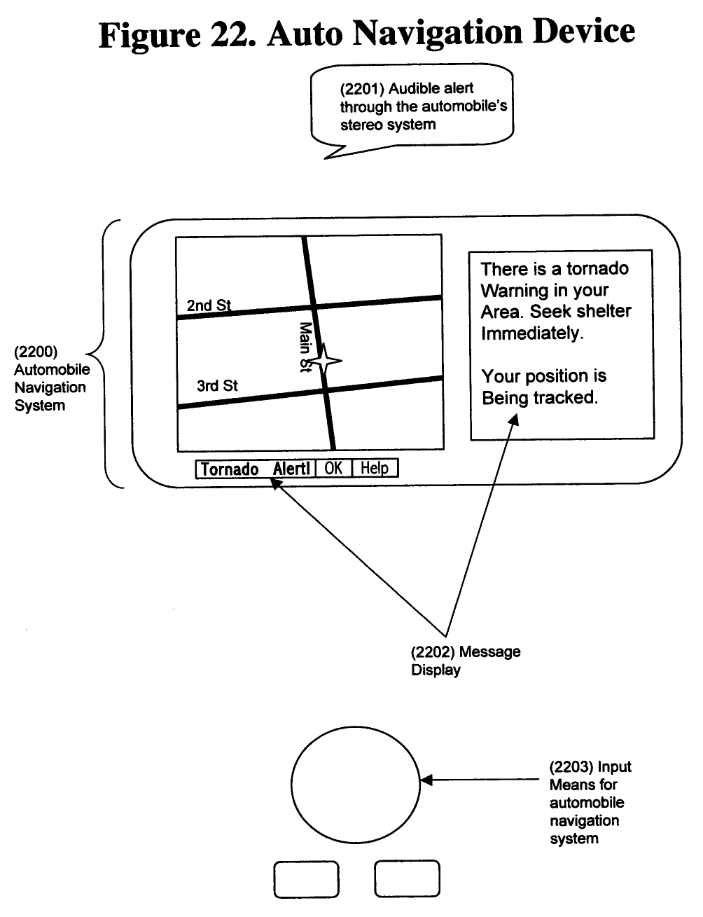

FIG. 22 illustrates how one embodiment of the alert system might look on an automobile navigation system. The application runs on the navigation system (2200) consisting of the speakers of the automobile's sound entertainment system (2201) to be used for audible alerts, a display to show alert messages (2202), and an input means for indicating whether or not the human operator is OK (2203).

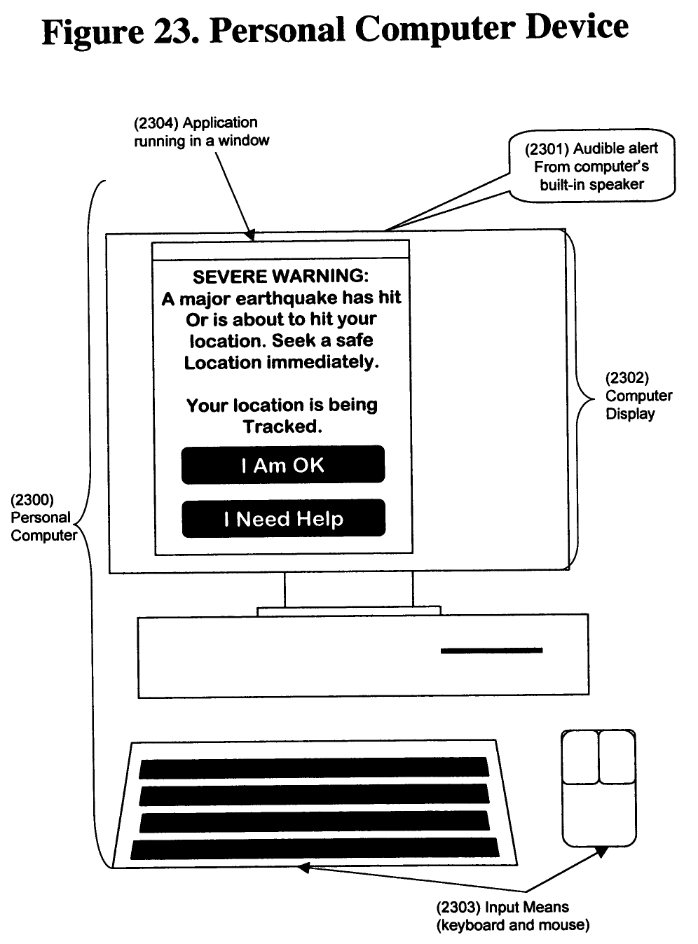

FIG. 23 illustrates how one embodiment of the alert system might look on a personal computer. The application runs on the personal computer (2300) consisting of built in speakers to be used for audible alerts (2301), a display to show the application window (2302), an application window within the display to display alert messages and provide user input controls (2304), and a keyboard and mouse as an input means for indicating whether or not the human operator is OK (2303).

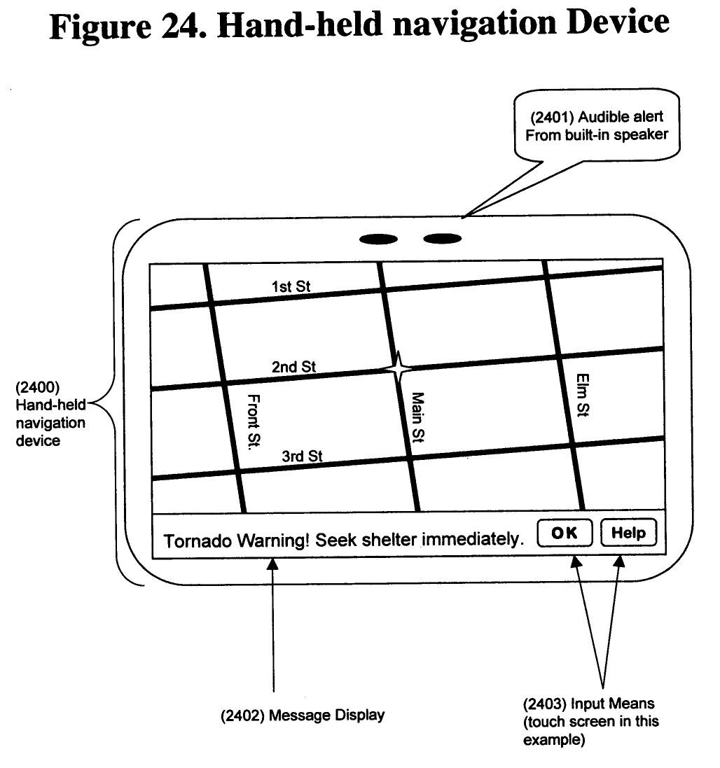

FIG. 24 illustrates how one embodiment of the alert system might look on a hand-held navigation system. The application runs on the navigation system (2400) consisting of a built in speaker to be used for audible alerts (2401), a display to display alert messages (2402), and an input means for indicating whether or not the human operator is OK (2403).

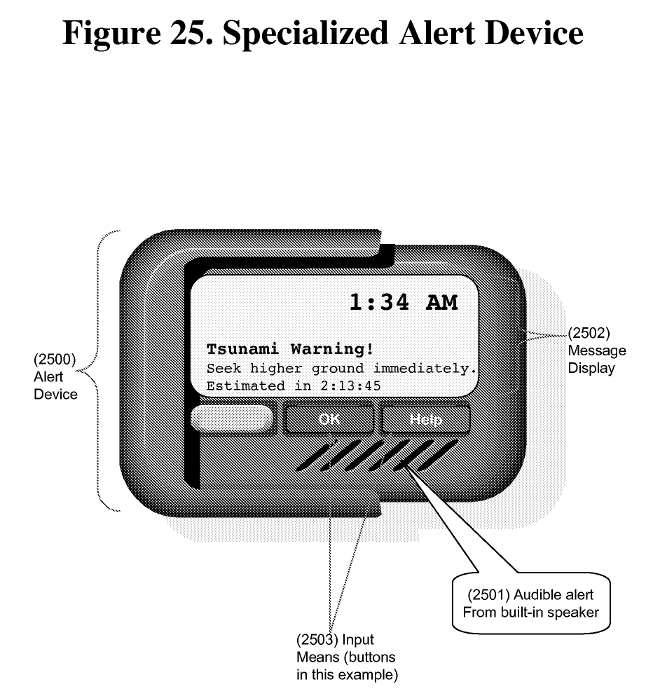

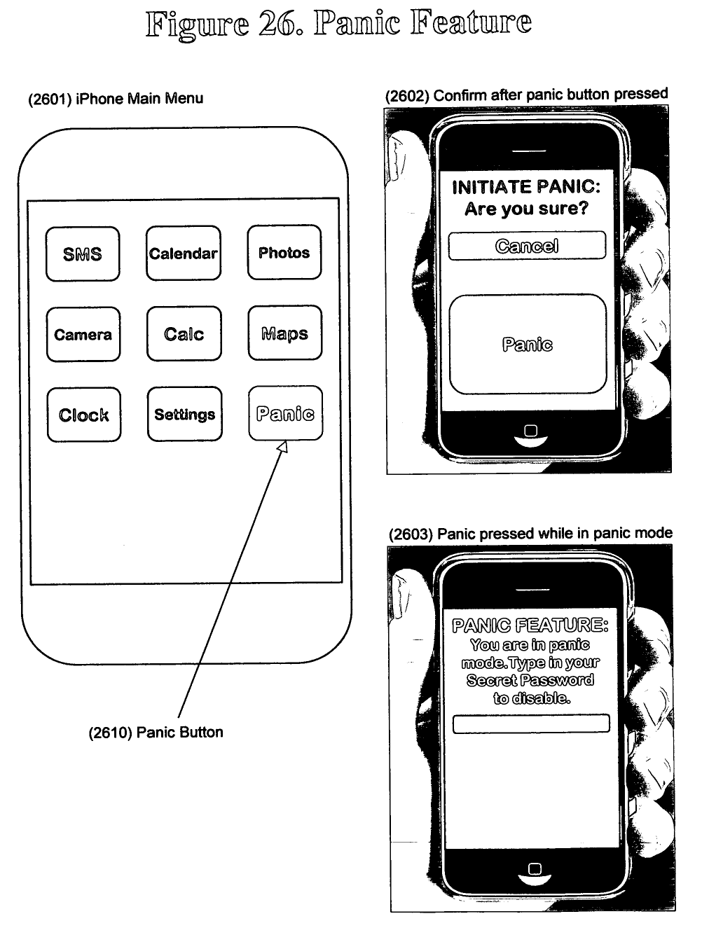

FIG. 25 illustrates how one embodiment of the alert system might look on a specialized mobile alert device. The application runs on the pager-like device (2500) consisting of a built in speaker for audible alerts (2501), a display to display alert messages (2505), and buttons to indicate whether or not the user is OK (2503).

Operation

The manner of using the emergency alert system as follows;

First, one must set up an account with the emergency alert system. In the preferred embodiment, the new customer accesses a website (FIG. 3), which provides an interface for creating and configuring a customer's account. An alternate embodiment may provide other means to create new accounts, such as filling out a form and having an operator enter relevant information into the system, or a simple signup interface accessible through a mobile phone or computer software on a computer.

In the preferred embodiment using the website, the customer accesses the front page of the website (301), chooses to sign up, and goes through the signup flow (FIG. 4). The customer enters personal information such as his/her name, primary address, primary email address, desired password, etc. and also confirms the terms of the user agreement. The customer also configures his/her list of emergency contacts, registers alert devices, adds any additional addresses to track, chooses optional subscription packages, selects an “OK” and “Not OK” password for the optional panic feature, and enters any other information and selects any other preferences necessary to configure the account.

The emergency alert system continuously checks its data feeds for new alerts and sends notifications to customers.

An e-mail is sent to each customer for each important alert, so customers can receive information simply by checking their email accounts.

If the customer has an alert device registered with the system, the alert system will send an alert to the alert device. The customer simply has to be near the alert device with the alert device turned on in order to receive the alert.

In the event of a basic mobile phone or other device capable of receiving text messages, a text message is sent to the device. If the customer has the device with him/ her and turned on, the customer will receive a text message to read.

In the event of an advanced device, for non-urgent messages, the message will be available to read similar to a text message. For urgent messages, an alarm will be sounded on the device so that the customer knows to immediately check the device to read the message. Optionally the alarm itself might give spoken information. For example, a mobile phone running an application supporting the emergency system might sound a loud alarm that says, “Tsunami Emergency!” in the event that a tsunami is known to exist and likely to affect the location of the device, whereas if there is simply a tsunami “watch” after an earthquake, there might be a brief soft chime and a written message.

A similar scenario applies to other types of warning devices, such as software running on a personal computer, the navigation system of a car, a weather radio type device, etc.

In the event that a severe emergency has struck in the area of the device, the device will ask the user if he/she is OK and record the user's response as well as the current location of the device. For example, if a tsunami strikes the coastal region of Oregon and within the timeframe that it hit that area, a mobile phone supporting advanced alert features was in the coastal region of Oregon, the phone will display a screen asking the customer to press ‘1’ if he/she is OK and any other key if he/she is not OK. The response (OK, not OK, or no response) is recorded along with the current position of the device.

The alert system then notifies the emergency contact list by e-mail, text message, or a message from an application running on a device supporting advanced alert features. In the tsunami example, emergency contacts would receive an urgent message that the customer was in or near an area affected by a tsunami, whether or not the customer is OK, and the longitude and latitude of the current position of the customer. The longitude and latitude could optionally be passed into a mapping software displaying the exact position on a map.

In the event that the emergency is approaching the device and/or the device is approaching the emergency, but the emergency has not yet reached the device, the device might also display a countdown of when the emergency will reach the device. The countdown could be in time (hours, minutes, seconds) or distance (miles or kilometers), or both. For example, if a tsunami is approaching the device, there could be a countdown in hours, minutes, and seconds as to when the tsunami is expected to reach the device. In the preferred embodiment, it is the responsibility of emergency contacts to contact emergency professionals about customers affected by emergencies, however the emergency alert system might optionally provide a service to alert emergency personnel.

Applications on advanced devices may support a panic feature. The operator would press a panic button and a panic alert would be sent to the central server of the alert system. Device location tracking and operator status tracking would also be activated.

### Additional Embodiments

Additional embodiments could include a similar system that does not use a website to open up customer accounts and get customer information. For example, an additional embodiment of the emergency alert system could be designed for automobile navigation systems for a particular automobile manufacturer. Accounts could be created by customer service people at the automobile manufacturer with one account per car and the only alert device being the navigation system of the car.

Another embodiment could use software in a mobile device or on a computer to create new accounts.

An embodiment of the system could also have a panic button on a mobile device supporting advanced features, in which case an alert is sent to emergency contacts and the current position of the mobile device is tracked. For example, if a woman is walking to her car in a parking lot at night and sees a strange guy following her, she could press a panic button on her mobile phone and her position starts recording and her husband is sent a message and alert sound on his mobile phone. If she then gets into her car and drives off OK, she can respond that she's OK on the mobile phone application, and that information is relayed to her husband.

### Alternative Embodiments

A particular embodiment of the emergency alert system could have different looks and feels for the website. There is a lot of variability in the possible database schema, the page layout for the website, the messages sent to users, or the way applications on alert devices interact with customers. The set of data feeds can also vary depending on the embodiment. There could be any number of types of alert devices, from mobile phones to pagers to advanced mobile devices to software running on a personal computer to automobile navigation systems to specialized “weather radio” type devices designed for this emergency alert system. A particular embodiment may or may not chose to integrate with a system that calculates an evacuation route. Current location tracking could also be a preference where it is always on, always off, or on only when within the area of effect of an emergency.

Advantages

From the description above, a number of advantages of some embodiments of our emergency alert system become evident:
(a) this emergency alert system can support any number of emergency alert data feeds, working in combination with each other, rather than relying on a single feed.
(b) This emergency alert system is capable of knowing the precise location of each device it is sending an alert to in the case of advanced alert devices. This allows a very high level of relevance with alerts that are sent. This also allows the system to alert you of disasters that affect your currently location, rather than a list of zip codes you provide the system. For example, if you are on vacation in Florida, you get alerts for Florida, not your primary residence in New York. A traditional text message or e-mail based alert system checks for alerts at your home address or a list of addresses.
(c) In the case of advanced mobile alert devices, such as mobile phones or car navigation systems, the device is likely to be in the same location as the person owning the device at the time the alert is sent to the device. This vastly increases the likelihood that the person will receive the alert, and decreases the amount of time it will take the person to receive the alert, relative to traditional alert systems like weather radios, emergency alert systems broadcast on television or radio, or emails. For example, people almost always have their mobile phone turned on and with them. If someone is in a business meeting, he or she is not going to receive emergency alerts by television, radio, e-mail, or text message, but he our she would receive an alert that sounds of an alarm on his or her mobile phone.
(d) Software running on an advanced alert device is able to sound special, highly noticeable alarms, whereas traditional text message based systems do not allow the customer to differentiate the text message from other text messages until he/she checks the message.
(e) When alerting an advanced alert device, our emergency alert system can determine whether or not the devices being alerted have been caught in the area of effect of an actual disaster or emergency. In these cases:
   a. The system can ask the customer if he/she is OK and receive and record that response. Traditional alert systems are unable to gather any information on the status of people these systems are sending alerts to.
   b. The system can begin tracking the current location of the customer while that customer is within the area of effect of an emergency.
(f) Unlike existing alert systems, this alert system notifies an emergency contact list for each customer and in the case where an advanced alert device is being used, this system can also relay the current status (OK, not OK, no answer) and position to the emergency contacts.
(g) By using the most advanced alert data feeds and a sophisticated message delivery system, it will be possible to alert people very rapidly. It may even be possible to alert people of earthquakes before the earthquake strikes a particular location. For example, if a mega-thrust earthquake ripped along the Cascadia fault line starting at the southern end, it might be possible to warn people seconds before the earthquake hits Portland and minutes before the earthquake hits Seattle.
(h) The optional panic feature, but working with emergency contacts instead of 9-11, makes people less concerned about potential false alarms, therefore more likely to use the system whenever there is an uncomfortable situation. The panic feature tracks the current position and works immediately, while 911 often does not track location and often takes minutes before an operator answers.
(i) This system will save lives. Many existing systems are focused on warning emergency workers but not civilians, or by broadcasting an alarm to devices unlikely to be turned on within an entire metropolitan area. In theory, it could be possible to warn someone in a brick building 30 seconds before a major earthquake strikes—giving them enough time to run out of the building before it collapses on top of him or her. This system has the potential to be able to alert civilians who will be affected by an impending disaster very rapidly. This system also makes it easier for friends and family to track the survivors in trouble, rather than leaving it entirely up to overwhelmed emergency workers.

Conclusion, Ramifications, and Scope

Accordingly, the reader will see that the emergency alert system of the various embodiments provides vast improvements over existing emergency alert systems, and is a life saving invention that provides a beneficial service to society. By knowing who the people receiving emergency alerts are, and by being able to determine if a particular customer is in the area of effect of an emergency when it happens, and by working through devices that people keep with them and turned on throughout the day and night, this emergency alert system is able to warn people intelligently and immediately. It is our goal to implement a system that can disseminate emergency alerts so quickly that we could even warn people seconds, or even minutes, before a major earthquake strikes, allowing people to escape from brick and concrete buildings, duck under a desk, pull their car over to the side of the road, etc. The best way to survive a disaster is to know it's coming before it hits you. The location aware nature of our system also ensures that a person receives proper emergency alert warnings, even if he or she is traveling or away from home.

Once disaster strikes, our emergency alert system can also track customer locations, confirm whether or not they are OK, and forward important information to their personal emergency contacts. This is a huge benefit over systems that simply send an alert with no follow-up, because it endeavors to help identify who needs to be rescued, their exact position, and initiates the rescue by passing this information on to friends and family of the people who need to be rescued. It is also our intent to try to develop relationships with emergency response organizations such as the National Guard to help relay this important data to rescue personnel.

Although the description above contains many specificities, these should not be construed as limiting the scope of the embodiment but as merely providing illustrations of some of the presently preferred embodiments. For example, the website component could be replaced with a printed application form that the customer fills out with a pen and the details are entered into the system through some operator software, or the website component could have a different look and feel, alterations in its flows, etc. The specific data sources for the alert system can vary, the actual text of alerts can vary, the sound of the alert alarm can vary, the types of alert devices can vary, etc.

Thus the scope of the embodiment should be determined by the appended claims and their legal equivalents, rather than by the examples given.

We claim:

1. A method of determining whether or not the device the method is running on is within the area of effect of an alert, comprising:
(a) providing a device running the method that is capable of:
(1) determining its current location,
(2) communicating with an emergency alert system,
(b) receiving alert messages that include:
(1) the nature of the actual alert,
(2) the area of effect of the alert,
(3) the expiration time or duration of the alert,
(c) providing a memory controller which will:
(1) store information from new alert messages,
(2) remove information pertaining to expired alert messages once they have expired,
(d) determining if the current location is within the boundaries of the area of effect of an alert,
(e) providing a notification means to notify a human operator when the current location is within the area of effect of an alert,
whereby the method causes said device running the method to notify said operator when said device is within the area of effect of an alert.

2. The method of claim 1 wherein:
(a) said device running the method is a mobile phone capable of determining its approximate current position and capable of communicating with an alert system through an internet enabled mobile phone network,
(b) said notification means is:
(1) an audible alarm emitted by said mobile phone,
(2) a written message describing the alert and shown on a display screen on said mobile phone,

3. The method of claim 1 wherein:
(a) said device running the method is an automobile navigation system capable of communicating with an alert system through a satellite link,
(b) said notification means is:
(1) an audible alarm transmitted through an audio system in said automobile,
(2) an annotation of the area of effect of the alert on the display map of said navigation system,
(3) a written message shown at the bottom of the display of said navigation system,

4. The method of claim 1 wherein:
(a) said device running the method is a laptop computer capable of determining its approximate current position and capable of communicating with an alert system through an internet connection,
(b) said notification means is:
(1) an audible alarm emitted by said laptop computer,
(2) a written message describing the alert and shown in an application window on said laptop computer,

5. The method of claim 1 wherein:
(a) said device running the method is a specialized stand alone alert device capable of communicating with an alert system through a mobile phone internet network,
(b) said notification means is:
(1) an audible alarm emitted by said stand alone alert device,
(2) a written message describing the alert and shown on a display screen on said stand alone alert device,

6. The method of claim 1 wherein:
(a) providing a central server
(b) providing a means for the method to send messages to said central server
whereby the method causes said device running the method to notify said operator when said device is within the area of effect of an alert, and the method notifies said central server that the device is within the area of effect of an alert.

7. The method of claim 6 whereby the method also sends the position of the device to said central server while the device running the method is within the area of effect of an alert.

8. The method of claim 6 wherein:
(a) providing a display to ask a human operator of the device what the status of that human operator is.
(b) providing an input device to retrieve a response from said human operator regarding the status of said human operator.
whereby the method also asks the human operator what said human operator's status is, retrieves a response, and forwards said response, including no response, to said central server.

9. The method of claim 6 wherein:
(a) providing a display to ask a human operator of the device what the status of that human operator is.
(b) providing an input device to retrieve a response from said human operator regarding the status of said human operator.
whereby the method also sends the position of the device to said central server while the device running the method is within the area of effect of an alert, and the method asks the human operator what said human operator's status is, retrieves a response, and forwards said response, including no response, to said central server.

10. The method of claim 9 wherein:
(a) said method has a panic feature wherein:
(1) said human operator of said device is provided with an input means to initiate a panic alert,
(2) said human operator of said device is provided with an input means to cancel a panic alert,
(3) said panic alerts are treated as if they are an alert type in which the device is within the area of effect of that alert,
whereby the method also sends a panic alert to said central server when said human operator initiates a panic alert through said provided input means, and the position of the device and status of said human operator is sent to said central server.

11. The method of claim 9 wherein:
(a) the location, speed, and direction of the alert event is relayed by the alert system to the device.
(b) The application running on the device calculates how long it will take until the alert event reaches the location of the device.
(c) The application displays and continuously updates the time until the alert event reaches the location of the device.
Whereby the method also displays a countdown of when the alert event will reach the location of the device.

12. The method of claims 10 and 11 whereby the method contains both the panic feature and the countdown feature.

13. The method of claim 12 wherein:
(a) said device is a mobile phone running the method
(b) said central server is a web server
whereby the method retrieves alert messages and compares the alert locations to the current location of the mobile phone, emits an audible alarm if the mobile phone is within the area of effect of an alert, displays alert details on the mobile phone screen, and asks the human operator to press the 1 key on the mobile phone's keypad if said operator is ok, and to press any other key if said operator is not ok, and the response, including no response, and position of the mobile phone are transmitted to the central web server using the mobile phone's internet connection.

14. The method of claim 12 wherein:
(a) said device is a navigation system running the method
(b) said central server is a web server
whereby the method retrieves alert messages and compares the alert locations to the current location of the navigation system, emits an audible alarm if the navigation system is within the area of effect of an alert, displays alert details on the navigation system screen, and asks the human operator to use the navigation system's user interface to indicate whether or not said human operator is ok, and the response, including no response, and position of the navigation system are transmitted to the central web server using the internet connection of a mobile phone.

15. The method of claim 12 wherein:
(a) said device is a personal computer running the method
(b) said central server is a web server
whereby the method retrieves alert messages and compares the alert locations to the current location of the computer, emits an audible alarm if the computer is within the area of effect of an alert, pops up a dialog box with details of the alert, and asks the human operator to click either an ok button or a not ok button, and the position of the computer and the status of the human operator, including no response, are transmitted to the central web server using the internet connection of the computer.

16. The method of claim 12 wherein:
(a) said device is a specialized alert device running the method,
(b) said central server is a web server,
whereby the method retrieves alert messages and compares the alert locations to the current location of the alert device, emits an audible alarm if the alert device is within the area of effect of an alert, displays the details of the alert on the display of the device, asks the human operator to press either an ok button or a not ok button, and the position of the alert device and the status of the human operator, including no response, are transmitted to the central web server using the internet connection of the alert device.

17. A machine for determining whether or not it is within the area of effect of an alert, comprising:
(a) a device capable of:
(1) determining its current location,
(2) communicating with an emergency alert system,
(b) a memory controller which will:
(1) store information from new alert messages,
(2) remove information pertaining to expired alert messages once they have expired,
(c) a notification means to notify a human operator when the current location is within the area of effect of an alert that has not expired,
(d) an emergency alert system that transmits alerts to said device,
whereby said device notifies said operator when said device is within the area of effect of an unexpired alert.

18. The machine of claim 14 wherein:
(a) said device running the method is a mobile phone capable of determining its approximate current position and capable of communicating with an alert system through an internet enabled mobile phone network,
(b) said notification means is:
(1) an audible alarm emitted by said mobile phone,
(2) a written message describing the alert and shown on a display screen on said mobile phone,

19. The machine of claim 17 wherein:
(a) said device running the method is an automobile navigation system capable of communicating with an alert system through a satellite link,
(b) said notification means is:
(1) an audible alarm transmitted through an audio system in said automobile,
(2) an annotation of the area of effect of the alert on the display map of said navigation system,
(3) a written message shown at the bottom of the display of said navigation system,

20. The machine of claim 17 wherein:
(a) said device running the method is a laptop computer capable of determining its approximate current position and capable of communicating with an alert system through an internet connection,
(b) said notification means is:
(1) an audible alarm emitted by said laptop computer,
(2) a written message describing the alert and shown in an application window on said laptop computer,

21. The machine of claim 17 wherein:
(a) said device running the method is a specialized stand alone alert device capable of communicating with an alert system through a mobile phone internet network,
(b) said notification means is:
(1) an audible alarm emitted by said stand alone alert device,
(2) a written message describing the alert and shown on a display screen on said stand alone alert device,

22. The machine of claim 17 comprising:
(a) a central server
(b) a means to send messages to said central server
whereby said device notifies said operator when said device is within the area of effect of an alert, and the device notifies said central server that the device is within the area of effect of an alert.

23. The machine of claim 22 whereby the machine also sends the position of the device to said central server while the device is within the area of effect of an alert.

24. The machine of claim 22 comprising:
(a) a display to ask a human operator of the device what the status of that human operator is.
(b) an input device to retrieve a response from said human operator regarding the status of said human operator.
whereby the machine also asks the human operator what the status of said human operator is, retrieves a response from said human operator, and forwards said response, including no response, to said central server.

25. The machine of claim 22 comprising:
(a) a display to ask a human operator of the device what the status of that human operator is.
(b) an input device to retrieve a response from said human operator regarding the status of said human operator.
whereby the machine also sends the position of the device to said central server while the device is within the area of effect of an alert, and the device asks the human operator what said human operator's status is, retrieves a response, and forwards said response, including no response, to said central server.

26. The machine of claim 25 wherein:
(a) said machine has a panic feature consisting of:
(1) an input means to allow said human operator to initiate a panic alert,
(2) an input means to allow said human operator to cancel a panic alert,
(3) said panic alerts are treated as if they are an alert type in which the device is within the area of effect of that alert,
whereby the machine also sends a panic alert to said central server when said human operator initiates a panic alert through said provided input means, and the position of the device and status of said human operator is sent to said central server.

27. The machine of claim 25 wherein:
(a) said machine has a countdown feature consisting of:
(1) providing the location, direction, and speed of the alert event,
(2) providing the time until the event reaches the location of the device is calculated,
(3) a display that indicates the continuously updated time until the event reaches the location of the device,
Whereby the machine also displays a countdown of when the alert event will reach the location of the device.

28. The machine of claims 26 and 27 whereby the machine contains both the panic feature and the countdown feature.

29. The machine of claim 28 wherein:
(a) said device is a mobile phone
(b) said central server is a web server
whereby the mobile phone retrieves alert messages and compares the alert locations to the current location of the mobile phone, emits an audible alarm if the mobile phone is within the area of effect of an alert, displays alert details on the mobile phone screen, and asks the human operator to press the 1 key on the mobile phone's keypad if said operator is ok, and to press any other key if said operator is not ok, and the response, including no response, and position of the mobile phone are transmitted to the central web server using the mobile phone's internet connection.

30. The method of claim 28 wherein:
(a) said device is a navigation system running the method
(b) said central server is a web server
whereby the machine retrieves alert messages and compares the alert locations to the current location of the navigation system, emits an audible alarm if the navigation system is within the area of effect of an alert, displays alert details on the navigation system screen, and asks the human operator to use the navigation system's user interface to indicate whether or not said human operator is ok, and the response, including no response, and position of the navigation system are transmitted to the central web server using the internet connection of a mobile phone.

31. The machine of claim 28 wherein:
(a) said device is a personal computer
(b) said central server is a web server
whereby the machine retrieves alert messages and compares the alert locations to the current location of the computer, emits an audible alarm if the computer is within the area of effect of an alert, pops up a dialog box with details of the alert, and asks the human operator to click either an ok button or a not ok button, and the position of the computer and the status of the human operator, including no response, are transmitted to the central web server using the internet connection of the computer.

32. The machine of claim 28 wherein:
(a) said device is a specialized alert device,
(b) said central server is a web server,
whereby the machine retrieves alert messages and compares the alert locations to the current location of the alert device, emits an audible alarm if the alert device is within the area of effect of an alert, displays the details of the alert on the display of the device, asks the human operator to press either an ok button or a not ok button, and the position of the alert device and the status of the human operator, including no response, are transmitted to the central web server using the internet connection of the alert device.

33. A method of tracking devices that are within the area of effect of an alert comprising:
(a) providing a storage means which stores:
(1) contact details for each registered device,
(2) the current location of each registered device,
(3) the area of effect of currently active alerts,
(b) providing an alert system that:
(1) collects alert information,
(2) stores the area of effect of currently active alerts in said storage means,
(c) providing registered devices that:
(1) determines the current location of said registered device,
(2) stores current location of said registered device in said storage means,
(d) providing a device registration means which a human operator can use to register said registered devices,
whereby said tracking method compares the area of effect of each active alert in said storage means with the current location of each registered device in said storage means to calculate which registered devices are within the area of effect of each active alert, resulting in an active list of devices currently within the area of effect of an alert.

34. The method of claim 33 wherein:
(a) said device registration means is a website providing a user interface for device registration,
(b) said storage means is a centralized database server,
(c) said registered devices are mobile phones capable of calculating their approximate current location and capable of connecting to the internet,
(d) said registered devices transmit their current locations to said storage means using an internet connection.

35. A method of tracking devices that are within the area of effect of an alert, comprising:
(a) providing a central server running the method,
(b) providing registered devices that:
(1) receive alerts from an emergency alert system,
(2) determine whether or not the device is within the area of effect of an alert,
(3) transmit to said central server whether or not said device is within the area of effect of an alert,
(c) providing a device registration means which a human operator can use to register said registered devices,
(d) providing a storage means which stores:
(1) contact details for each said registered device,
(2) whether or not each said registered device is in the area of effect on an active alert,
whereby the device tracking method receives status messages from said registered devices indicating whether or not each device is in the area of effect of an alert, and the device tracking method saves the status of each registered device in said storage means, resulting in an active list of devices currently within the area of effect of an alert.

36. The method of claim 35 wherein:
(a) said device registration means is a website providing a user interface for device registration,
(b) said storage means is a centralized database server,
(c) said registered devices are mobile phones capable of calculating their approximate current location that receive alert messages from an emergency alert system,
(d) said central server running the method is a web server capable of receiving messages from said mobile phones over the internet.

37. The method of claim 35 wherein:
(a) said device registration means is an intranet providing a user interface for employees of an automobile company to register navigation systems on automobiles manufactured by said automobile company,
(b) said storage means is a centralized database server,
(c) said registered devices are navigation systems in automobiles manufactured by said company, and said navigation systems are capable of:
(1) calculating their current location,
(2) receiving alert messages from an emergency alert system,
(3) broadcasting information to said central server using a mobile phone data network,

38. A machine for tracking devices that are within the area of effect of an alert, comprising:
(a) a storage means which stores:
(1) contact details for each registered device,
(2) the current location of each registered device,
(3) the area of effect of currently active alerts,
(b) an alert system that:
(1) collects alert information,
(2) stores the area of effect of currently active alerts in said storage means,
(c) registered devices that:
(1) determines the current location of said registered device,
(2) stores current location of said registered device in said storage means,
(d) a device registration means which a human operator can use to register said registered devices,
whereby the area of effect of each active alert in said storage means is compared with the current location of each registered device in said storage means to calculate which registered devices are within the area of effect of each active alert, resulting in an active list of devices currently within the area of effect of an alert.

39. The machine of claim 38 wherein:
(a) said device registration means is a website providing a user interface for device registration,
(b) said storage means is a centralized database server,
(c) said registered devices are mobile phones capable of calculating their approximate current location and capable of connecting to the internet,
(d) said registered devices transmit their current locations to said storage means using an internet connection.

40. A machine for tracking devices that are within the area of effect of an alert, comprising:
(a) a central server,
(b) registered devices that:
(1) receive alerts from an emergency alert system,
(2) determine whether or not the device is within the area of effect of an alert,
(3) transmit to said central server whether or not said device is within the area of effect of an alert,
(c) a device registration means which a human operator can use to register said registered devices,
(d) a storage means which stores:
(1) contact details for each said registered device,
(2) whether or not each said registered device is in the area of effect on an active alert,
whereby the device tracking machine receives status messages from said registered devices indicating whether or not each device is in the area of effect of an alert, and the device tracking machine saves the status of each registered device in said storage means, resulting in an active list of devices currently within the area of effect of an alert.

41. The machine of claim 36 wherein:
(a) said device registration means is a website providing a user interface for device registration,
(b) said storage means is a centralized database server,
(c) said registered devices are mobile phones capable of calculating their approximate current location that receive alert messages from an emergency alert system,
(d) said central server is a web server capable of receiving messages from said alert devices over the internet.

42. The machine of claim 40 wherein:
(a) said device registration means is an intranet providing a user interface for employees of an automobile company to register navigation systems on automobiles manufactured by said automobile company,
(b) said storage means is a centralized database server,
(c) said registered devices are navigation systems in automobiles manufactured by said company, and said navigation systems are capable of calculating their approximate current location and receive alert messages from an emergency alert system,
(d) said central server receives messages from said navigation systems over the data network of a mobile phone network.

43. A method of tracking the positions of registered devices while they are in the area of effect of an active alert, comprising:
(a) providing a central server running the method,
(b) providing registered devices that:
(1) receive alerts from an emergency alert system,
(2) determine whether or not the device is within the area of effect of an alert,
(3) transmit to said central server their current positions while in the area of effect of an alert,
(c) providing a device registration means which a human operator can use to register said registered devices,
(d) providing a storage means which stores:
(1) contact details for each said registered device,
(2) the position of registered devices within the area of effect of active alerts,
whereby the device position tracking method receives current position messages from said registered devices while said registered devices are within the area of effect of an active alert, but without having knowledge of positions when said devices are not in the area of effect of an active alert, resulting in a list of positions of devices within the area of effect of active alerts without intruding on the privacy of human operators of said devices when said devices are not within the area of effect of an active alert.

44. The method of claim 43 wherein:
(a) said device registration means is a website providing a user interface for device registration,
(b) said storage means is a centralized database server,
(c) said registered devices are mobile phones capable of calculating their approximate current location that receive alert messages from an emergency alert system,
(d) said central server running the method is a web server capable of receiving messages from said mobile phones over the internet.

45. The method of claim 43 wherein:
(a) said device registration means is an intranet providing a user interface for employees of an automobile company to register navigation systems on automobiles manufactured by said automobile company,
(b) said storage means is a centralized database server,
(c) said registered devices are navigation systems in automobiles manufactured by said company, and said navigation systems are capable of:
(1) calculating their current location,
(2) receiving alert messages from an emergency alert system,
(3) broadcasting information to said central server using a mobile phone data network,

46. The method of claim 43 wherein:
(a) said device registration means is both a website accessible to the public and an intranet providing a user interface for employees of an automobile company to register navigation systems on automobiles manufactured by said automobile company,
(b) said storage means is a centralized database server,
(c) said registered devices are mobile phones, navigation systems in automobiles manufactured by said company, and other devices all of which are capable of:
(1) calculating their current location,
(2) receiving alert messages from an emergency alert system,
(3) broadcasting information to said central server using some form of internet connection,

47. A machine for tracking the positions of registered devices while they are within the area of effect of an active alert comprising:
(a) a central server,
(b) registered devices that:
(1) receive alerts from an emergency alert system,
(2) determine whether or not the device is within the area of effect of an alert,
(3) transmit to said central server their current positions while in the area of effect of an alert,
(c) a device registration means which a human operator can use to register said registered devices,
(d) a storage means which stores:
(1) contact details for each said registered device,
(2) whether or not each said registered device is in the area of effect on an active alert,
whereby the device tracking machine receives status messages from said registered devices indicating whether or not each device is in the area of effect of an active alert, and the device tracking machine saves the status of each registered device in said storage means, resulting in a list of devices currently within the area of effect of an active alert.

48. The machine of claim 47 wherein:
(a) said device registration means is a website providing a user interface for device registration,
(b) said storage means is a centralized database server,
(c) said registered devices are mobile phones capable of calculating their approximate current location that receive alert messages from an emergency alert system,
(d) said central server is a web server capable of receiving messages from said alert devices over the internet.

49. The machine of claim 47 wherein:
(a) said device registration means is an intranet providing a user interface for employees of an automobile company to register navigation systems on automobiles manufactured by said automobile company,
(b) said storage means is a centralized database server,
(c) said registered devices are navigation systems in automobiles manufactured by said company, and said navigation systems are capable of calculating their approximate current location and receive alert messages from an emergency alert system,
(d) said central server receives messages from said navigation systems over the data network of a mobile phone network.

50. The machine of claim 47 wherein:
(a) said device registration means is both a website accessible to the public and an intranet providing a user interface for employees of an automobile company to register navigation systems on automobiles manufactured by said automobile company,
(b) said storage means is a centralized database server,
(c) said registered devices are mobile phones, navigation systems in automobiles manufactured by said company, and other devices all of which are capable of:
(1) calculating their current location,
(2) receiving alert messages from an emergency alert system,
(3) broadcasting information to said central server using some form of internet connection,

51. A method of tracking the status of human operators of registered devices while they are in the area of effect of an active alert, comprising:
(a) providing a central server running the method,
(b) providing registered devices that:
(1) receive alerts from an emergency alert system,
(2) determine whether or not the device is within the area of effect of an alert,
(3) provide a display to ask the human operator of said device what the current status is of said human operator,
(4) provide an input means which a human operator can use to indicate the current status of said human operator,
(4) transmit to said central server the status response of said human operator while said device is in the area of effect of an alert,
(c) providing a device registration means which a human operator can use to register said registered devices,
(d) providing a storage means which stores:
(1) contact details for each said registered device,
(2) whether or not the human operators of registered devices within the area of effect of an alert are harmed, unharmed, or there is no response,
whereby the method of tracking the status of human operators of registered devices receives human operator status messages from said registered devices while said registered devices are within the area of effect of active alerts, resulting in a list of human operator statuses of devices within the area of effect of active alerts, making it possible to determine which human operators need emergency assistance.

52. The method of claim 51 wherein:
(a) said device registration means is a website providing a user interface for device registration,
(b) said storage means is a centralized database server,
(c) said registered devices are mobile phones that:
(1) are capable of calculating their approximate current location
(2) receive alert messages from an emergency alert system,
(3) display a question on said mobile phone's display screen asking the human operator whether or not said human operator is harmed when the mobile phone is within the area of effect of an alert,
(4) receive a response from human operator using the mobile phone's keypad,
(5) transmit response from human operator, including a no response code if there is no response, to said central server,
(d) said central server running the method is a web server capable of receiving messages from said mobile phones over the internet.

53. The method of claim 51 wherein:
(a) said device registration means is an intranet providing a user interface for employees of an automobile company to register navigation systems on automobiles manufactured by said automobile company,
(b) said storage means is a centralized database server,
(c) said registered devices are navigation systems in automobiles manufactured by said company, and said navigation systems are capable of:
(1) calculating their current location,
(2) receiving alert messages from an emergency alert system,
(3) display a question on said navigation system's display screen asking the human operator whether or not said human operator is harmed when the navigation system is within the area of effect of an alert,
(4) receive a response from human operator using the navigation system's user interface controls,
(5) transmit response from human operator, including a no response code if there is no response, to said central server.

54. The method of claim 51 wherein:
(a) said device registration means is both a publicly accessible website to register mobile phones and other devices, and an intranet providing a user interface for employees of an automobile companies to register navigation systems on automobiles manufactured by said automobile company,
(b) said storage means is a centralized database server,
(c) said registered devices are mobile phones, navigation systems in automobiles, and other devices capable of:
(1) calculating their current location,
(2) receiving alert messages from an emergency alert system,
(3) display a question on the display screen of said device asking the human operator whether or not said human operator is harmed when the device is within the area of effect of an alert,
(4) receive a response from human operator using the user interface controls of said device,
(5) transmit response from human operator, including a no response code if there is no response, to said central server.

55. A machine for tracking the status of human operators of registered devices while they are in the area of effect of an active alert, comprising:
(a) a central server running the method,
(b) registered devices that:
(1) a means of receiving alerts from an emergency alert system,
(2) a means of determining whether or not the device is within the area of effect of an alert,
(3) display to ask the human operator of said device what the current status of said human operator is,
(4) an input means which a human operator can use to indicate the current status of said human operator,
(4) a means to transmit to said central server the status response of said human operator while said device is in the area of effect of an alert,
(c) a device registration means which a human operator can use to register said registered devices,
(d) a storage means which stores:
(1) contact details for each said registered device,
(2) whether or not the human operators of registered devices within the area of effect of an alert are harmed, unharmed, or there is no response,
whereby the machine for tracking the status of human operators of registered devices receives human operator status messages from said registered devices while said registered devices are within the area of effect of active alerts, resulting in a list of human operator statuses of devices within the area of effect of active alerts, making it possible to determine which human operators need emergency assistance.

56. The machine of claim 51 wherein:
(a) said device registration means is a website providing a user interface for device registration,
(b) said storage means is a centralized database server,
(c) said registered devices are mobile phones that:
(1) are capable of calculating their approximate current location
(2) receive alert messages from an emergency alert system,
(3) display a question on said mobile phone's display screen asking the human operator whether or not said human operator is harmed when the mobile phone is within the area of effect of an alert,
(4) receive a response from human operator using the mobile phone's keypad,
(5) transmit response from human operator, including a no response code if there is no response, to said central server,
(d) said central server is a web server capable of receiving messages from said mobile phones over the internet.

57. The machine of claim 55 wherein:
(a) said device registration means is an intranet providing a user interface for employees of an automobile company to register navigation systems on automobiles manufactured by said automobile company,
(b) said storage means is a centralized database server,
(c) said registered devices are navigation systems in automobiles manufactured by said company, and said navigation systems are capable of:
(1) calculating their current location,
(2) receiving alert messages from an emergency alert system,
(3) display a question on said navigation system's display screen asking the human operator whether or not said human operator is harmed when the navigation system is within the area of effect of an alert,
(4) receive a response from human operator using the navigation system's user interface controls,
(5) transmit response from human operator, including a no response code if there is no response, to said central server.

58. The machine of claim 51 wherein:
(a) said device registration means is both a publicly accessible website for registering mobile phones and other devices, and an intranet providing a user interface for employees of automobile companies to register navigation systems on automobiles manufactured by said automobile company,
(b) said storage means is a centralized database server,
(c) said registered devices are mobile phones, navigation systems in automobiles, and other devices that are capable of:
(1) calculating their current location,
(2) receiving alert messages from an emergency alert system,
(3) display a question on the display of said device asking the human operator whether or not said human operator is harmed when said device is within the area of effect of an alert,
(4) receive a response from human operator using the user interface controls of said device,
(5) transmit response from human operator, including a no response code if there is no response, to said central server.

59. A method of notifying the emergency contact lists of registered users when said users are affected by an alert, comprising:
(a) providing an alert system,
(b) providing a list of registered users,
(c) providing a means for determining whether or not each registered user is within the area of effect of an alert,
(d) providing a list of emergency contacts for each registered user,
(e) providing a means to contact each emergency contact,
whereby the method of notifying emergency contacts notifies each emergency contact for each registered user within the area of effect of an alert using the provided means to contact each emergency contact, resulting in emergency contacts being notified when a registered user is within the area of effect of an alert.

60. The method of claim 59, wherein:
(a) providing a central server that runs the method of notifying the emergency contacts,
(b) the provided means for determining whether or not each registered user is within the area of effect of an alert is through registered devices which:
(1) are connected to said alert system,
(2) are able to determine whether or not they are in the area of effect of an alert,
(3) transmit whether or not the device is within the area of effect of an alert to said central server,

61. The method of claim 59, wherein:
(a) providing a central server that runs the method of notifying the emergency contacts,
(b) the provided means for determining whether or not each registered user is within the area of effect of an alert is through registered devices which:
(1) are connected to said alert system,
(2) are able to determine whether or not they are in the area of effect of an alert,
(3) transmit whether or not the device is within the area of effect of an alert to said central server,
(4) transmit the location of the device to said central server while the device is within the area of effect of an alert,
(5) transmit the status of the human operator of the device to said central server while the device is within the area of effect of an alert,
Whereby the registered devices receive alerts from an alert system and automatically notify the central server when a registered device is within the area of effect of an alert, and transmit to said central server the location of the device and the status of the human operator, and the method running on said central server notifies each emergency contact and relays the position of the device and the status of the human operator of said device to each emergency contact.

62. The method of claim 61, wherein:
(a) providing the registered devices have a panic feature wherein:
(a) providing a user interface to initiate a panic alert,
(b) providing a user interface to cancel a panic alert,
Whereby in addition to the functionality of claim 57, the registered devices may send a panic alert along with a device location and status of human operator, and the method running on said central server notifies each emergency contact and relays the position of the device and the status of the human operator of said device to each emergency contact.

63. The method of claim 62, wherein:
(a) said central server is connected to the internet,
(b) said registered devices are mobile phones, such as in claim 13,
(c) providing a website user interface for:
(1) registering users
(2) registering devices
(3) registering emergency contacts

64. The method of claim 62, wherein:
(a) said central server is connected to the internet,
(b) said registered devices are navigation systems in automobiles, such as in claim 14,
(c) providing an intranet user interface for human operators at the automobile company producing the automobiles with said navigation systems for:
(1) registering users
(2) registering devices
(3) registering emergency contacts

65. The method of claim 62, wherein:
(a) said central server is connected to the internet,
(b) said registered devices are mobile phones such as in claim 13, navigation systems in automobiles, such as in claim 14, and other devices,
(c) providing both a publicly accessible website to register mobile phones and other devices, and an intranet user interface for human operators at automobile companies to register navigation systems, users, and emergency contacts.

66. A machine for notifying the emergency contact lists of registered users when said users are affected by an alert, comprising:
(a) an alert system,
(b) a list of registered users,
(c) a means for determining whether or not each registered user is within the area of effect of an alert,
(d) a list of emergency contacts for each registered user,
(e) a means to contact each emergency contact,
whereby the machine for notifying emergency contacts notifies each emergency contact for each registered user within the area of effect of an alert using the provided means to contact each emergency contact, resulting in emergency contacts being notified when a registered user is within the area of effect of an alert.

67. The machine of claim 66, wherein:
(a) a central server notifies the emergency contacts,
(b) the means for determining whether or not each registered user is within the area of effect of an alert is through registered devices which:
(1) are connected to said alert system,
(2) are able to determine whether or not they are in the area of effect of an alert,
(3) transmit whether or not the device is within the area of effect of an alert to said central server,

68. The machine of claim 66, wherein:
(a) a central server notifies the emergency contacts,
(b) the means for determining whether or not each registered user is within the area of effect of an alert is through registered devices which:
(1) are connected to said alert system,
(2) are able to determine whether or not they are in the area of effect of an alert,
(3) transmit whether or not the device is within the area of effect of an alert to said central server,
(4) transmit the location of the device to said central server while the device is within the area of effect of an alert,
(5) transmit the status of the human operator of the device to said central server while the device is within the area of effect of an alert,
Whereby the registered devices receive alerts from an alert system and automatically notify the central server when a registered device is within the area of effect of an alert, and transmit to said central server the location of the device and the status of the human operator, and said central server notifies each emergency contact and relays the position of the device and the status of the human operator of said device to the emergency contact.

69. The machine of claim 68, comprising:
(a) the registered devices have a panic feature comprising:
(a) a user interface to initiate a panic alert,
(b) a user interface to cancel a panic alert,
Whereby in addition to the functionality of claim 68, the registered devices may send a panic alert along with a device location and status of human operator, and the method running on said central server notifies each emergency contact and relays the position of the device and the status of the human operator of said device to each emergency contact.

70. The machine of claim 69, comprising:
(a) said central server is connected to the internet,
(b) said registered devices are mobile phones, such as in claim 13,
(c) comprising a website user interface for:
(1) registering users
(2) registering devices
(3) registering emergency contacts

71. The machine of claim 69, comprising:
(a) said central server is connected to the internet,
(b) said registered devices are navigation systems in automobiles, such as in claim 14,
(c) comprising an intranet user interface for human operators at the automobile company producing the automobiles with said navigation systems for:
(1) registering users
(2) registering devices
(3) registering emergency contacts

72. The machine of claim 69, comprising:
(a) said central server is connected to the internet,
(b) said registered devices are mobile phones, such as in claim 13, navigation systems in automobiles, such as in claim 14, and other devices,
(c) comprising both a publicly accessible website and an intranet user interface for human operators at automobile companies for:
(1) registering users
(2) registering devices
(3) registering emergency contacts
